(19) United States
(12) Patent Application Publication
(10) Pub. No.: US 2026/0316650 A1
(43) Pub. Date: Oct. 15, 2026

(54) CHILD SAFETY SEAT

(71) Applicant: WONDERLAND SWITZERLAND AG, Steinhausen (CH)

(72) Inventors: Ganqing FANG, Dongguan (CN); Daliang ZHANG, Dongguan (CN); Ruyi LI, Dongguan (CN)

(21) Appl. No.: 19/476,545

(22) PCT Filed: Apr. 12, 2024
(86) PCT No.: PCT/EP2024/060021

§ 371 Date: Oct. 17, 2025

(30) Foreign Application Priority Data
Apr. 17, 2023 (CN) 202310409462.8
Nov. 7, 2023 (CN) 202311473180.0
Dec. 8, 2023 (CN) 202311691891.5
Apr. 2, 2024 (CN) 202410401052.3

(51) Int. Cl. B60N 2/90; B60N 2/28

(52) U.S. Cl. CPC B60N 2/995; B60N 2/2812; B60N 2/2821; B60N 2/2851; B60N 2/2875

(57) ABSTRACT

The present disclosure provides a child safety seat. The child safety seat includes a seat part; a support plate disposed at a front end of the seat part and be slidable and telescopic with respect to the seat part; and a base configured to place the seat part. The support plate includes a support plate body and a first connecting element. One end of the first connecting element is fixed on the support plate body. The other end of the first connecting element extends from the support plate body and is inserted into the seat part. The support plate according to the present disclosure can be used in conjunction with different vehicle models, and can provide a large space for legs of a child sitting on the child safety seat so as to provide more safety and comfort experience.

This application is a National Stage application of PCT/EP2024/060021, entitled “CHILD SAFETY SEAT” and filed on Apr. 12, 2024, which claims the benefit of Chinese Applications No. 202310409462.8, filed on Apr. 17, 2023, No. 202311473180.0, filed on Nov. 7, 2023, No. 202311691891.5, filed on Dec. 8, 2023, No. 202410401052.3, filed on Apr. 2, 2024, both of which are incorporated herein by reference in their entirety.

### TECHNICAL FIELD

The present disclosure relates to the field of child products, in particular to a child safety seat, and more specifically to a seat angle adjustment mechanism and a child safety seat having the seat angle adjustment mechanism.

### BACKGROUND

In recent years, with increasing attention on children's travel safety, more and more people choose to use the child safety seats. Generally, a front end of the child safety seat may be provided with a support plate to prevent the child safety seat from being overturned by abutting against a backrest of a vehicle seat when the child safety seat is used in a rear-facing mode.

In addition, some of the child safety seats may also be provided with a seat angle adjustment mechanism to provide different seat angles for children seated in the child safety seats.

### SUMMARY

In an aspect, the present disclosure provides a child safety seat. The child safety seat includes a seat part; a support plate disposed at a front end of the seat part and be slidable and telescopic with respect to the seat part; and a base configured to place the seat part. The support plate includes a support plate body and a first connecting element. One end of the first connecting element is fixed on the support plate body. The other end of the first connecting element protrudes from the support plate body and is inserted into the seat part, so that the support plate can be slidably connected to the seat part.

In an embodiment, an upper surface of the support plate body is provided with a second connecting element which is in sliding engagement with a lower surface of the seat part. The second connecting element is a guiding rib or a guiding groove.

In an embodiment, the support plate is provided with a support plate adjustment mechanism for adjusting a length of the support plate protruding from the seat part. The support plate adjustment mechanism includes a positioning structure movably disposed on the support plate body so as to be able to position the support plate in at least one position of the seat part.

In an embodiment, the positioning structure includes a first locking element, the first locking element is disposed at the support plate body and is movable between a locking position and an unlocking position. The lower surface of the seat part is provided with a second locking element. The upper surface of the support plate body is provided with a through hole passing therethrough. An engaging end of the first locking element can extend and retract from the through hole to engage with and disengage from the second locking element.

In an embodiment, the first locking element is a locating hook pivoted to a lower surface of the support plate body, and the locating hook can be pivoted so that the engaging end protrudes from the upper surface of the support plate body when it is in the locking position, and retracts into the support plate body when it is in the unlocking position.

In an embodiment, the first locking element is a positioning pin, and the second locking element is a positioning hole.

In an embodiment, a plurality of second locking elements are disposed in a front and rear direction of the seat part. The positioning structure further includes an elastic element, and the elastic element is disposed to bias the first locking element towards a direction extending out of the through hole.

In an embodiment, the support plate adjustment mechanism further includes an operating mechanism, and the operating mechanism is at least partially movably disposed on the support plate. The operating mechanism includes an operating element slidably disposed on the support plate and capable of sliding between a locking position and a releasing position. When the operating element is in the locking position, the operating element drives the positioning structure to lock the support plate and the seat part so as to limit movement of the support plate with respect to the seat part. When the operating element is in the releasing position, the operating element drives the positioning structure to be unlocked, so as to allow the support plate to move with respect to the seat part.

In an embodiment, the first connecting element includes two connecting tubes, and the connecting tubes are disposed at two sides of the support plate body. Two ends of the operating element are socketed on the two connecting tubes respectively, so as to be able to slide the operating element in a direction of extension of the connecting tube. The operating element is provided with a pushing rib thereon, and the pushing rib has a guiding bevel. When the operating element slides, the guiding bevel moves against the first locking element from the locking position to the unlocking position.

In an embodiment, the positioning structure includes a first positioning structure and a second positioning structure, and the first positioning structure and the second positioning structure are disposed at two sides of the support plate body of the support plate respectively. The support plate adjustment mechanism further includes a first traction element and a second traction element. One end of the first traction element is connected to the operating element, and the other end is connected to the first positioning structure. One end of the second traction element is connected to the operating element, and the other end is connected to the second positioning structure. When the operating element slides from the locking position to the releasing position, the first traction element pulls the first positioning structure to be unlocked, and the second traction element pulls the second positioning structure to be unlocked. At least one of the first traction element and the second traction element is a flexible element.

In an embodiment, the operating mechanism includes two operating elements which are slidably disposed at two sides of the support plate respectively and slidable between a locking position and a releasing position, at least a portion of each of the operating elements is exposed from the support plate; two driving elements which are slidably disposed on the support plate respectively and movable along with operation of the corresponding operating element; and two traction element sets, each of the traction element sets includes a first traction element and a second traction element. The first traction element is configured to be connected between the operating element and the driving element located at the same side of the support plate, so that the driving element is linked with the operating element. The second traction element is connected between the operating element at one side of the support plate and the driving element at the other side of the support plate.

In an embodiment, the first traction element includes a first traction wire having a first end, a wire body portion and a second end, and the first end and the second end of the first traction wire are fixedly connected to the operating element and the driving element at the same side respectively, so that the driving element is driven to move when the operating element is operated.

In an embodiment, the first traction element further includes a first sheath, and the first sheath is sleeved on the first traction wire.

In an embodiment, the first traction element includes a first traction wire and a first sheath. The first end of the first traction wire is fixedly connected to the driving element at the same side, and the second end of the first traction wire is fixedly connected to the support plate. The first sheath is sleeved on the first traction wire, a first end of the first sheath abuts against the support plate, and a second end of the first sheath is connected with the operating element.

In an embodiment, the second traction element includes a second traction wire and a second sheath. A first end of the second traction wire is connected to the operating element on one side of the support plate, and a second end of the second traction wire is connected to the driving element on the other side of the support plate. The second sheath is sleeved on the second traction wire, a first end of the second sheath is fixed on one side of the support plate, and a second end of the second sheath is fixed on the other side of the support plate.

In an embodiment, the first locking element is fixedly disposed on a fixing seat at an end of the support plate. The operating mechanism is provided with an inclined slot thereon, and the inclined slot is slidingly fit to the fixing seat through a linkage pin disposed on the fixing seat. When the operating mechanism is operated, the operating mechanism moves the fixing seat through the inclined slot so as to drive the first locking element to disengage from the seat part.

In an embodiment, the support plate body is provided with a limiting rib, the seat part includes a cover at a front side, and the cover is provided with a limiting slot, and a vertical segment of the limiting rib can be blocked by a blocking part of the limiting slot, so as to prevent the support plate from being separated from the seat part.

The present disclosure provides a child safety seat. The child safety seat includes a seat part; a support plate disposed at a front end of the seat part and be slidable and telescopic with respect to the seat part; a positioning structure movably disposed on the support plate body, so as to be able to position the support plate in at least one position of the seat part; and an operating mechanism disposed on the support plate to drive the positioning structure to lock and unlock the support plate and the seat part, wherein the operating mechanism includes two operating elements disposed at two sides of the support plate or the seat part respectively; two driving elements movably disposed on the support plate respectively and be movable along with operation of the corresponding operating element; and two traction element sets, each of which includes a first traction element and a second traction element, wherein the first traction element is configured to be connected between the operating element and the driving element located at the same side of the support plate, so that the driving element is linked with the operating element, and the second traction element is connected between the operating element located at one side of the support plate and the driving element located at the other side of the support plate, wherein at least one of the first traction element and the second traction element is a flexible element.

In an embodiment, the child safety seat further includes a base, the base is configured to place the seat part, and the seat part is slidable with respect to the base to adjust an inclination angle.

In another aspect, the present disclosure also provides a headrest height adjustment mechanism. The headrest height adjustment mechanism includes:
an operating element slidably disposed on a headrest, and having an initial position, a first operating position and a second operating position with respect to the headrest;
a locking assembly configured to be locked with a height adjustment apparatus, the locking assembly having a locking position and an unlocking position and be able to be switched between the locking position and the unlocking position; and
a safety lock mechanism including a limiting element disposed on the operating element and an engaging element disposed on the locking assembly, wherein the limiting element is matched with the engaging element to lock the locking assembly in the locking position, and wherein as the operating element is switched from the initial position to the first operating position, the limiting element is separated from the engaging element, so as to enable the safety lock mechanism to unlock the locking assembly; and as the operating element is switched from the first operating position to the second operating position, the locking assembly is switched from the locking position to the unlocking position.

In an embodiment, the headrest height adjustment mechanism further includes a driving element, one end of the driving element is slidably connected to the operating element, and the other end of the driving element abuts against the locking assembly. As the operating element is switched from the first operating position to the second operating position, the driving element moves and drives the locking assembly to be switched from the locking position to the unlocking position.

In an embodiment, the locking assembly is rotatably switched between the locking position and the unlocking position under driving of the driving element.

In an embodiment, the locking assembly includes a locking body and a locking rod configured to be locked with the height adjustment apparatus, wherein one end of the locking body is provided with a pivoting part pivoted with the headrest, and the locking rod is fixed at the other end of the locking body.

In an embodiment, the limiting element is a stop pin disposed on the operating element, the engaging element is an engaging groove disposed on the locking body. The stop pin is inserted into the engaging groove to lock the locking assembly in the locking position, and is disengaged from the engaging groove so as to enable the safety lock mechanism to unlock the locking assembly.

In an embodiment, the operating element includes a handle and a transmission element connected with the handle, the stop pin is connected with the transmission element, and an extension direction of the stop pin is the same as a movement direction of the transmission element.

In an embodiment, the locking body is provided with a fitting bevel, and the driving element is provided with a driving bevel corresponding to the fitting bevel. Movement of the driving element enables the driving bevel to press against the fitting bevel, so that the locking rod rotates with respect to the pivoting part.

In an embodiment, the locking assembly further includes a first elastic element abutting against the locking body, and the first elastic element provides an elastic force to keep the locking rod locked with the height adjustment apparatus.

In an embodiment, the operating element is provided with a sliding groove, the driving element includes a pulling element located in the sliding groove. When the operating element moves between the initial position and the first operating position, the pulling element slides in the sliding groove, and as the operating element is switched from the first operating position to the second operating position, the pulling element moves together with the operating element and drives the locking assembly to be switched from the locking position to the unlocking position.

In an embodiment, the headrest height adjustment mechanism further includes a second elastic element disposed between the headrest and the operating element, and the second elastic element provides an elastic force to keep the operating element in the initial position.

In an embodiment, the operating element is provided with an accommodating groove and a hanging hole adjacent to the accommodating groove, one end of the second elastic element is fixed to the hanging hole, a body of the second elastic element is located in the accommodating groove, and one end of the second elastic element is fixed with the headrest.

A baby carrier includes a carrier body, a headrest movably disposed on the carrier body, and the headrest height adjustment mechanism according to any one of the above embodiments between the carrier body and the headrest. The carrier body includes the height adjustment apparatus locked with the locking assembly of the headrest height adjustment mechanism.

In an embodiment, the carrier body includes a backrest, the headrest is movably disposed on the backrest, and the height adjustment apparatus is disposed on the backrest. A height of the headrest can be adjusted with respect to the backrest by cooperation of the height adjustment mechanism and the height adjustment apparatus.

In an embodiment, the headrest includes a fixing cover plate, and the pivoting part of the locking body is rotatably disposed on the fixing cover plate.

The headrest height adjustment mechanism is provided with a safety lock mechanism, and the operating element has an initial position, a first operating position and a second operating position, and the safety lock mechanism is driven to unlock the locking assembly by switching of the operating element from the initial position to the first operating position, so that a subsequent unlocking operation can only be carried out when the operating element moves to the first operating position. At the same time, one end of the driving element is slidably disposed on the operating element, and the other end of the driving element abuts against the locking assembly. By switching the operating element from the first operating position to the second operating position, the driving element moves and drives the locking assembly to be switched from the locking position to the unlocking position, so as to achieve unlocking. In other words, when the operating element is in the initial position, the locking rod of the locking assembly can be firmly locked with the height adjustment apparatus under the action of the safety lock mechanism, and even if the baby carrier is hit by some collision during the emergency braking of the vehicle, the locking rod will not be easily separated from the height adjustment apparatus, thereby reducing the possibility of location jumping in the height adjustment apparatus and improving the safety of the baby carrier.

In another aspect, the present disclosure provides a crotch belt length adjustment device for a child carrier. The crotch belt length adjustment device includes a crotch belt having a movable end detachably connected to a seat part of the child carrier, wherein the movable end is provided with a plurality of crotch belt adjustment structures arranged along a length direction of the crotch belt; an adjustment connecting element arranged on the seat part, wherein the adjustment connecting element is capable of being engaged with one of the crotch belt adjustment structures on the movable end to prevent a corresponding movable end from moving away from the seat part, and being disengaged from the crotch belt adjustment structure to allow the corresponding movable end to move away from the seat part.

In an embodiment, the crotch belt adjustment structure is one or more of an adjusting sleeve, an adjusting ring, an adjusting hook and an adjusting rod.

In an embodiment, the crotch belt adjustment structure is an adjusting sleeve formed by folding an end of the crotch belt with respect to the crotch belt itself for several times.

In an embodiment, the adjustment connecting element is disposed on the seat part to be movable between a first position and a second position, and the adjustment connecting element is disposed to be engaged with one of the crotch belt adjustment structures at the first position and disengaged from the crotch belt adjustment structures at the second position.

In an embodiment, the adjustment connecting element is provided with a connecting element engagement part which is engaged with or disengaged from one of the crotch belt adjustment structures.

In an embodiment, the seat part is provided with a seat part connecting hole, and the connecting element engagement part of the adjustment connecting element is accommodated in the seat part connecting hole after being engaged with one of the crotch belt adjustment structures.

In an embodiment, the crotch belt length adjustment device further includes an adjustment operating element, and the adjustment operating element is disposed to be exposed from the seat part and can be applied with an action force to drive the adjustment connecting element to move between the first position and the second position.

In an embodiment, the adjustment operating element is movably arranged on the seat part, and the adjustment connecting element is connected with the adjustment operating element.

In an embodiment, the adjustment connecting element also has a connecting element driving part connected with the adjustment operating element.

In an embodiment, the adjustment operating element is provided with an operating element fixing hole, the connecting element driving part is provided with a connecting element fixing hole, and a connecting element fixing structure passes through the operating element fixing hole and the connecting element fixing hole to connect the adjustment connecting element with the adjustment operating element.

In an embodiment, a cross section of the connecting element driving part is non-circular, and the adjustment operating element is provided with an operating element connecting groove, and a shape and a size of a cross section of the operating element connecting groove correspond to a shape and a size of the cross section of the connecting element driving part, so that the connecting element driving part cannot rotate in the operating element connecting groove.

In an embodiment, the crotch belt length adjustment device further includes an operating element guiding structure arranged on the seat part and disposed to guide movement of the adjusting operating element.

In an embodiment, the operating element guiding structure is a strip structure, and two ends of the operating element guiding structure is fixed on the seat part through a guiding structure fixing element.

In an embodiment, the crotch belt length adjustment device further includes an operating element restoring elastic element, and the operating element restoring elastic element is disposed to directly or indirectly drive the adjustment connecting element to move towards the first position and keep it in the first position.

In an embodiment, the operating element restoring elastic element is a tension spring having a restoring elastic element first end and a restoring elastic element second end, wherein the restoring elastic element first end is connected to a restoring elastic element connecting structure on the seat part, and the restoring elastic element second end is connected to a restoring elastic element connecting part on the adjustment operating element.

In an embodiment, the adjustment operating element is provided with a restoring elastic element accommodation part for accommodating the operating element restoring elastic element therein.

In an embodiment, the crotch belt is provided with a fastener.

In an embodiment, the fastener is provided with fastener perforations through which the crotch belt passes.

In an embodiment, the crotch belt has a first end and a second end, and at least one of the first end and the second end is the movable end.

In another aspect, the present disclosure further provides a child carrier, wherein the child carrier adopts the crotch belt length adjustment device as mentioned above.

The crotch belt length adjustment device according to the present disclosure can adjust the length of the crotch belt at different locations.

The foregoing and other objects, features, aspects and advantages of the present disclosure will become more apparent from the following detailed description of the present disclosure taken in conjunction with the accompanying drawings.

### BRIEF DESCRIPTION OF THE DRAWINGS

The accompanying drawings, which are included to provide a further understanding of the present disclosure and are incorporated in and constitute a part of this specification, illustrate embodiments of the present disclosure and together with the description as described below serve to explain the concept of the present disclosure.

FIG. 1 is a side view of a child safety seat provided with a support plate according to an embodiment of the present disclosure, in which the support plate is in a retracted position.

FIG. 2A is a side view of the child safety seat provided with the support plate according to an embodiment of the present disclosure, in which the support plate is in an extended position.

FIG. 2B is a cross-sectional view taken along a line “A-A” in FIG. 2A and a partial enlarged view of the child safety seat.

FIG. 3 is a perspective view and a partial enlarged view of the child safety seat in FIG. 2A when viewed from below after the support plate is removed.

FIG. 4 is a perspective view and a partial enlarged view of one example of the support plate according to an embodiment of the present disclosure.

FIG. 5 is a partial enlarged perspective view of the child safety seat in FIG. 2A when viewed from below.

FIG. 6 is a partial enlarged view of one example of the support plate according to an embodiment of the present disclosure when viewed from below.

FIG. 7A is a bottom view of the child safety seat in FIG. 2A.

FIG. 7B is a cross-sectional view taken along a line “B-B” in FIG. 7A and a partial enlarged view of the child safety seat.

FIG. 8A is a perspective view of the child safety seat in FIG. 2A when viewed from above.

FIG. 8B is a side partial cross-sectional view taken along a line “C-C” in FIG. 8A and a partial enlarged view of the child safety seat.

FIG. 9 is a side cross-sectional view and a partial enlarged view of the child safety seat in FIG. 2A.

FIG. 10 shows a perspective view of the child safety seat according to another embodiment of the present disclosure.

FIG. 11 shows a perspective view of another state of the child safety seat shown in FIG. 10.

FIG. 12 shows a side cross-sectional view of the child safety seat shown in FIG. 11.

FIG. 13 shows a perspective view of the child safety seat viewed from another angle according to another embodiment of the present disclosure.

FIG. 14 shows a perspective view of the child safety seat viewed from yet another angle according to another embodiment of the present disclosure.

FIG. 15 shows a perspective view of the support plate according to another embodiment of the present disclosure.

FIG. 16 shows a partial perspective view of the child safety seat according to another embodiment of the present disclosure.

FIG. 17 shows a perspective view of the child safety seat according to another embodiment of the present disclosure, in which a bottom cover plate between the support plate and a seat part is removed.

FIG. 18 shows a partial perspective view of the child safety seat according to another embodiment of the present disclosure, in which an upper cover of the support plate is removed.

FIG. 19 shows a partial perspective view of the child safety seat shown in FIG. 17 in another state.

FIG. 20 shows a perspective view of a base according to another embodiment of the present disclosure.

FIG. 21 shows another partial perspective view of the child safety seat according to another embodiment of the present disclosure, in which the upper cover of the support plate is removed.

FIG. 22 shows a top partial perspective view of the support plate and the seat part according to another embodiment of the present disclosure.

FIG. 23 shows a cross-sectional view taken along a line “D-D” in FIG. 22.

FIG. 24 shows a perspective view of the support plate according to another embodiment of the present disclosure, in which the upper cover and a bottom plate are removed.

FIG. 25 shows another side cross-sectional view of the child safety seat according to another embodiment of the present disclosure.

FIG. 26 shows a perspective view of a child safety seat according to another embodiment of the present disclosure.

FIG. 27 shows a perspective view of the child safety seat shown in FIG. 26 in another state.

FIG. 28 shows a perspective view of the child safety seat shown in FIG. 27 from another angle.

FIG. 29 shows a perspective view of a support plate shown in FIG. 28.

FIG. 30 shows another perspective view of the support plate shown in FIG. 29, in which an upper cover of the support plate is removed.

FIG. 31 shows a partial perspective view of the child safety seat shown in FIG. 27 from another angle, in which the upper cover of the support plate is removed.

FIG. 32 is a perspective schematic view of a baby carrier according to an embodiment.

FIG. 33 is a schematic view of an internal structure of the baby carrier shown in FIG. 32.

FIG. 34 is a perspective schematic view of a headrest height adjustment mechanism according to an embodiment.

FIG. 35 is an exploded perspective view of the headrest height adjustment mechanism shown in FIG. 34.

FIG. 36 is an enlarged view of a locking body shown in FIG. 35.

FIG. 37 is an enlarged view of an operating element shown in FIG. 35.

FIG. 38 is a perspective schematic view of the operating element and a locking assembly in one state.

FIG. 39 is a perspective schematic view of the operating element and the locking assembly in another state.

FIG. 40 is an enlarged view of a driving element shown in FIG. 35.

FIG. 41A is a perspective schematic view of the operating element and the locking assembly shown in FIG. 38 from another angle.

FIG. 41B is a front view when the operating element is matched with the driving element.

FIG. 42 is a cross-sectional view of the operating element in an initial position.

FIG. 43 is a partial enlarged view at a part A shown in FIG. 42.

FIG. 44 is a cross-sectional view of the operating element in a first operating position.

FIG. 45 is a cross-sectional view of the operating element in a second operating position.

FIG. 46A is a schematic view of a child carrier using a crotch belt length adjustment device according to the present disclosure.

FIG. 46B is a partial enlarged view of FIG. 46A.

FIG. 47A is a schematic view of the child carrier shown in FIG. 46A, in which a part of the seat part is removed.

FIG. 47B is a partial enlarged view of FIG. 47A.

FIG. 48 is a schematic view of a crotch belt and a fastener of the crotch belt length adjustment device according to the present disclosure shown in FIG. 46A.

FIG. 49A is a front partial sectional view of the child carrier shown in FIG. 46A.

FIG. 49B is a partial enlarged view of FIG. 49A.

FIG. 50A is a lateral partial cross-sectional view of the child carrier shown in FIG. 46A, in which a connected state of an operating element restoring elastic element is shown.

FIG. 50B is a partial enlarged view of FIG. 50A.

FIG. 51A is a schematic view of the child carrier shown in FIG. 46A from another angle.

FIG. 51B is a partial enlarged view of FIG. 51A.

FIG. 52A is a lateral partial cross-sectional view of the child carrier shown in FIG. 46A, in which an adjustment connecting element is shown in a first position.

FIG. 52B is a partial enlarged view of FIG. 52A.

FIG. 53A is a lateral partial cross-sectional view of the child carrier shown in FIG. 46A, in which the adjustment connecting element is shown in a second position.

FIG. 53B is a partial enlarged view of FIG. 53A.

FIG. 54 is a schematic view of an embodiment of an adjustment operating element of the crotch belt length adjustment device according to the present disclosure.

FIG. 55 is a schematic view of the embodiment of the adjustment operating element shown in FIG. 54 from another angle.

FIG. 56 is a schematic view of an embodiment of an adjustment connecting element of the crotch belt length adjustment device according to the present disclosure.

### LIST OF REFERENCE NUMBERS

100 Support Plate
110 Support Plate Body
110A Upper Surface
110B Lower Surface
110C Through Hole
111 Limiting Rib
111A Vertical Segment
120 Second Connecting Element
130 First Locking Element
131 Engaging End
140 Operating Element
141 Pushing Rib
150 Connecting Tube
160 Elastic Element
200 Seat Part
210 Cover
211 Limiting Slot
211A Blocking Part
220 Sliding Element
230 Second Locking Element
250 Connecting Hole
300 Support Plate
310 Support Plate Body
311 Upper Cover
312 Lower Cover
312A Window
313 Bottom Plate
313a Extension
3131 Receiving Slot
320 First Connecting Element
330 Second Connecting Element
340 Support Plate Adjustment Mechanism
341 Operating Element
3411 Inclined Slot
342 Elastic Element
343 Positioning Structure
3431 First Locking Element
3432 Fixing Seat
3433 Return Spring
3434 Linkage Pin
3435 Inclined Slot
350 First Limiting Piece
400 Seat Part
401 Connecting Hole
402 Sliding Element
410A Sliding Member
410B Sliding Member
410C Connecting Column
421 Unlocking Operating Member
422 Connecting Member
423 Reset Member
424 Angle Locking Structure
4241 Engaging Pin
4242 Engaging Reset Member
430 Second Locking Element
440 Second Limiting Piece
500 Base
510 Engaging Hole
520A Sliding-fit Member
520B Sliding-fit Member
600 Support Plate
610 Support Plate Body
611 Upper Cover
612 Lower Cover
613 Bottom Plate
620 First Connecting Element
640 Support Plate Adjustment Mechanism
641 Operating Element
642 Elastic Element
643 Positioning Structure
6431 First Locking Element
6432 Fixing Seat
6434 Linkage Pin
644 Traction Element
6441 First Traction Element
6441a First Traction Wire
6441b First Sheath
6442 Second Traction Element
6442a Second Traction Wire
6442b Second Sheath
645 Driving Element
6451 Driving Element Return Spring
6452 Inclined Slot
700 Seat Part
730 Second Locking Element
M100 Baby Carrier
M10 Headrest Height Adjustment Mechanism
M12 Operating Element
M122 Handle
M124 Transmission Element
M1242 Accommodating Groove
M1244 Hanging Hole
M1246 Sliding Groove
M14 Locking Assembly
M142 Locking Body
M143 First Elastic Element
M144 Locking Rod
M146 Pivoting Part
M147 Fitting Bevel
M148 Fixing Part
M16 Safety Lock Mechanism
M162 Stop Pin
M164 Engaging Groove
M18 Driving Element
M181 Inserting Slot
M182 Body Part
M183 Positioning Hole
M184 Abutting Part
M186 Pulling Element
M188 Driving Bevel
M19 Second Elastic Element
M20 Carrier Body
M201 Height Adjustment Apparatus
M202 Backrest
M30 Headrest
M32 Limiting Plate
M322 Limiting Slot
M34 Positioning Plate
M342 Fixing Hook
M36 Fixing Cover Plate
N1 Child Carrier
N10 Seat Part
N112 Restoring Elastic Element Connecting Structure
N20 Fastener
N21 Fastener Perforation
N100 Crotch Belt
N101 First End
N101C First Crotch Belt Adjustment Structure
N102 Second End
N102C Second Crotch Belt Adjustment Structure
N300 Adjustment Operating Element
N310 Operating Element Restoring Elastic Element
N310A Restoring Elastic Element First End
N310B Restoring Elastic Element Second End
N311 Restoring Elastic Element Blocking Element
N320 Operating Element Guiding Structure
N321 Guiding Structure Fixing Element
N330 Operating Element Fixing Hole
N340 Operating Element Connecting Groove
N350 Restoring Elastic Element Connecting Part
N360 Operating Element Stress Part
N370 Restoring Elastic Element Accommodating Part
N400 Adjustment Connecting Element
N410 Connecting Element Engaging Part
N420 Connecting Element Driving Part
N421 Connecting Element Fixing Hole
N430 Connecting Fixing Structure

### DETAILED DESCRIPTION

Hereinafter, exemplary embodiments of the present disclosure will be described in detail with reference to the accompanying drawings. While the present disclosure may be modified or substituted in various forms, specific embodiments thereof are shown by way of examples in the accompanying drawings. However, the present disclosure should not be construed as limiting the embodiments as set forth herein, on the contrary, the present disclosure is intended to cover all modifications, equivalents, and alternatives within the spirit and scope of the present disclosure.

Hereinafter, the present disclosure will be described in detail with reference to the accompanying drawings.

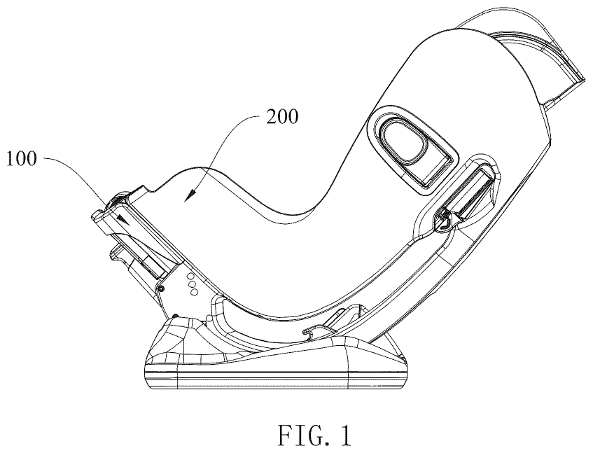

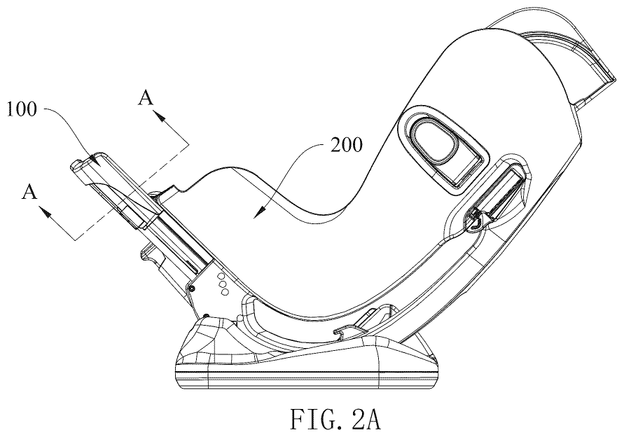

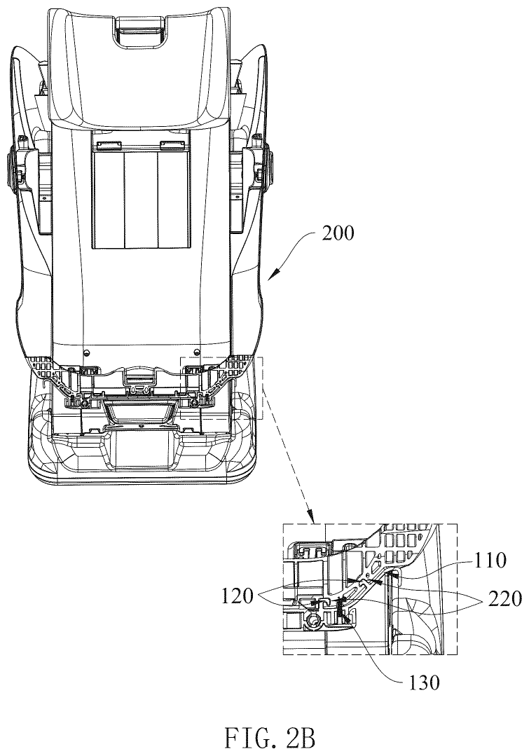

In one embodiment of the present disclosure, a child safety seat is provided. Specifically, FIGS. 1, 2A and 2B show a child safety seat provided with a support plate 100 according to the present disclosure. The support plate 100 may be slidably connected to a seat part 200 of the child safety seat, for example, connected to a lower front side of the seat part 200, and may be slidable forward and rearward and be positioned between a retracted position shown in FIG. 1 and an extended position shown in FIG. 2A. Herein, referring to FIG. 1, a direction towards which the child safety seat faces may be defined as “front”, and a direction from which the child safety seat faces away may be defined as “rear”. The support plate 100 may slide forward and rearward along the seat part 200 and be positioned at different positions, such that the support plate 100 according to the present disclosure can be used in conjunction with different vehicle models, and can provide a large space for legs of a child sitting on the child safety seat so as to provide more safety and comfort experience.

Specifically, the support plate 100 according to the present disclosure includes a support plate body 110 and a second connection element 120 disposed on the support plate body 110. The support plate body 110 may be, for example, in a plate shape, or in other shapes such as a block shape. The second connection element 120 may be slidingly fit to a second sliding element 220 disposed on the seat part 200, so that the support plate 100 may slide forward and rearward along the seat part 200.

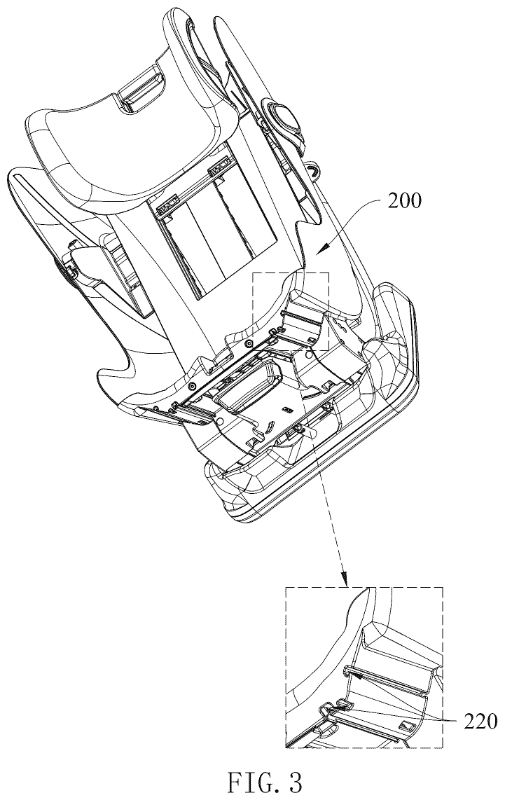

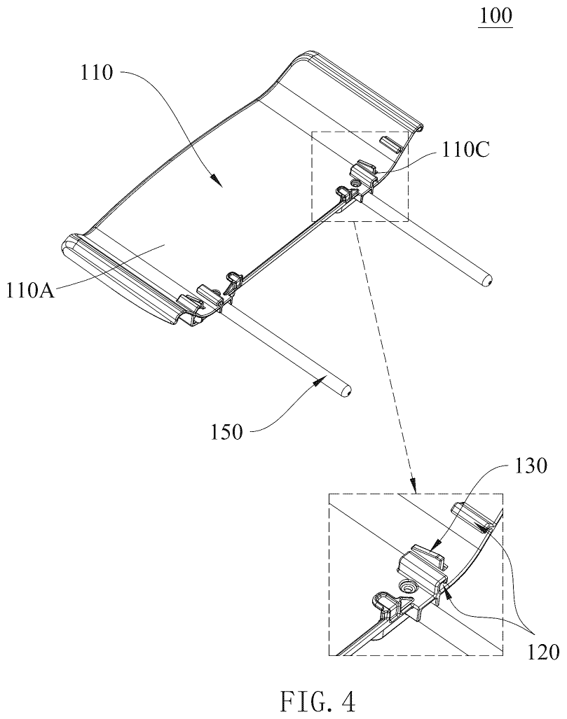

In an embodiment shown in FIGS. 2B, 3 and 4, the second connection element 120 may be a sliding rib located on an upper surface 110A of the support plate body 110 (see FIG. 4), and the second sliding element 220 may be a sliding slot located on a lower surface of the seat part 200 (see FIG. 3). The sliding rib on the support plate body 110 of the support plate 100 may be inserted into the sliding slot on the seat part 200 and slidable in the sliding slot, so that the support plate 100 may slide forward and rearward along the seat part 200.

In addition, the first sliding part 120 may also be a sliding slot on the upper surface 110A of the support plate body 110, and the second sliding part 220 may also be a sliding rib on the lower surface of the seat part 200.

Of course, the present disclosure may not be limited thereto. The second connection element 120 disposed on the support plate body 110 and the second sliding element 220 disposed on the seat part 200 may also use other sliding-fit structures, as long as the support plate 100 can slide with respect to the seat part 200. For example, the second connection element 120 may be a sliding rod disposed on the support plate body 110, and the second sliding element 220 may be a sliding ring disposed on the seat part 200.

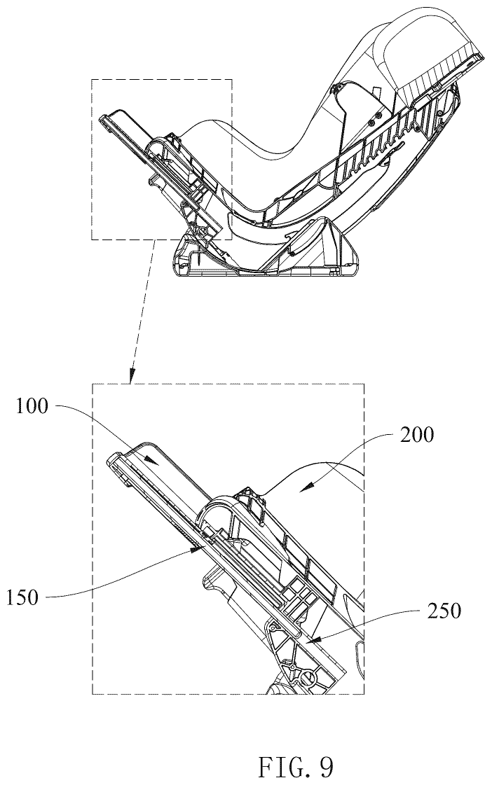

In one embodiment, as shown in FIGS. 4 and 9, the support plate 100 according to the present disclosure may further include a first connecting element fixedly connected to the support plate body 110. The first connecting element can be a connecting rod or a connecting tube (also referred to as a reinforcing rod or reinforcing tube), but the present disclosure is not limited thereto. The following will be illustrated using a connecting tube 150 as an example, a connecting hole 250 into which the connecting tube 150 is inserted may be formed on the seat part 200. After the support plate 100 is assembled to the seat part 200, the connecting tube 150 may be inserted into the connecting hole 250, and as the support plate 100 is slidable and adjustable with respect to the seat part 200, the connecting tube 150 may be slidable in the connecting hole 250, so that the support plate 100 may be guided to slide along the seat part 200 forward and rearward, and when the support plate 100 protrudes out of a front side of the seat part 200, especially when a part of the support plate 100 protruding from the front side of the seat part 200 is larger than a part hidden in the lower surface of the seat part 200, the connecting tube 150 inserted into the connecting hole 250 can greatly enhance the supporting capacity of the support plate 100.

In the embodiment shown in FIG. 4, two reinforcing tubes 150 fixedly connected to the support plate body 110 of the support plate 100 may be provided and are respectively located on left and right sides of the support plate body 110 of the support plate 100, to evenly share a stress applied by the support plate 100. The number and shape of the reinforcing tubes 150 may vary as desired. For example, there may be one, three or more reinforcing tubes 150, and the reinforcing tubes 150 may be not only in a shape of a circular tube or a square tube, but also in other shapes such as a solid rod, and the present disclosure is not limited thereto. Correspondingly, the connecting hole 250 into which the connecting tube 150 is inserted may also have a number and shape corresponding to that of the reinforcing tubes. Materials of the connecting tube 150 may be different from that of the support plate 100 and the seat part 200, such as a metal having strong rigidity, preferably stainless steel, carbon steel, and the like.

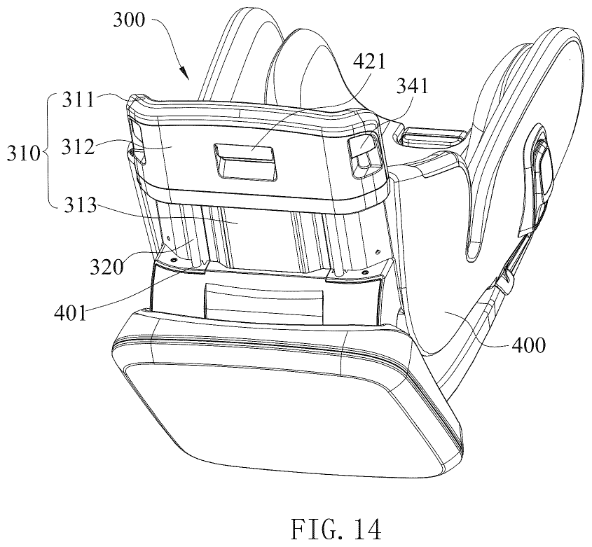

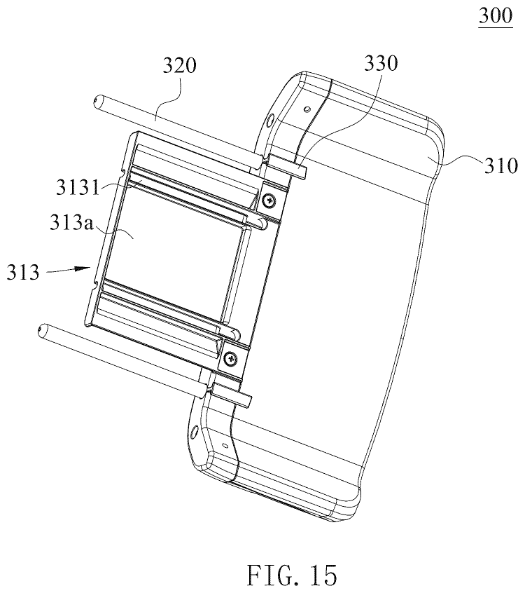

It should be noted that the support plate 100 may also be slidably connected to the seat part 200 only through the connecting element (such as “the connecting tube 150” in the above-mentioned embodiment), that is, without the cooperation between the first sliding element and the second sliding element. Regarding this embodiment, reference may also be made to the description in conjunction with FIGS. 14 and 15 below.

When the support plate 100 may be slidable between the extended position and the retracted position, the support plate 100 according to the present disclosure may further include a first locking element 130, in order to adjust and position the support plate 100 at different positions with respect to the seat part 200, such that the support plate may be used in different vehicle models. The first locking element 130 is disposed on the support plate body 110 and may be movable between a locking position and an unlocking position. When the first locking element 130 is in the locking position, it may engage with a second locking element 230 on the seat part 200 such that the support plate 100 may be positioned with respect to the seat part 200. When the first locking element 130 is in the unlocking position, it disengages from the second locking element 230 on the seat part 200 such that the support plate 100 may be slidable with respect to the seat part 200 and may be adjusted to a proper position.

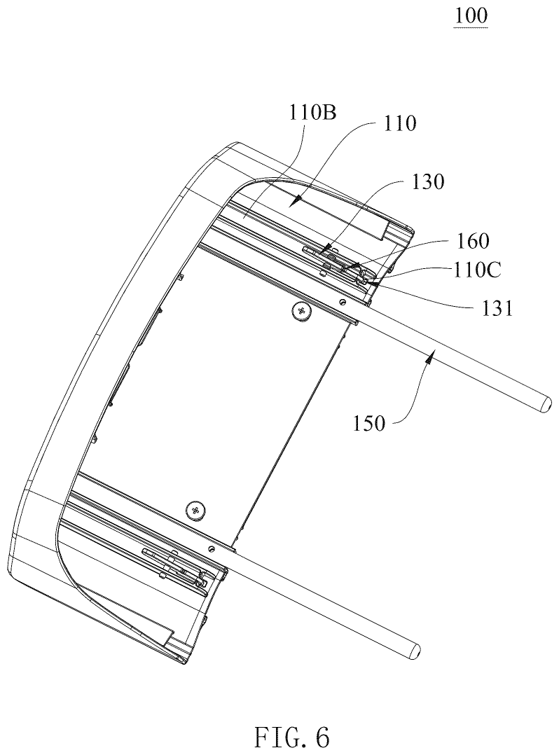

The first locking element 130 may be disposed on the lower surface 110B of the support plate body 110, and when it is in the locking position, at least a portion of the first locking element 130, e.g., the engaging end 131, may pass through a through hole 110C on the support plate body 110 and protrude or retract from the upper surface 110A of the support plate body 110, to engage with or disengage from the second locking element 230 on the seat part 200. For example, in the embodiment shown in FIGS. 4, 6 and 7B, the first locking element 130 is a strip pivotally connected to the lower surface 110B of the support plate body 110 (see FIG. 6) or locating hook. The strip may be pivotable so that when it is in the locking position, the engaging end 131 thereon may pass through the support plate body 110 and protrude from the upper surface 110A of the support plate body 110 (see FIG. 4).

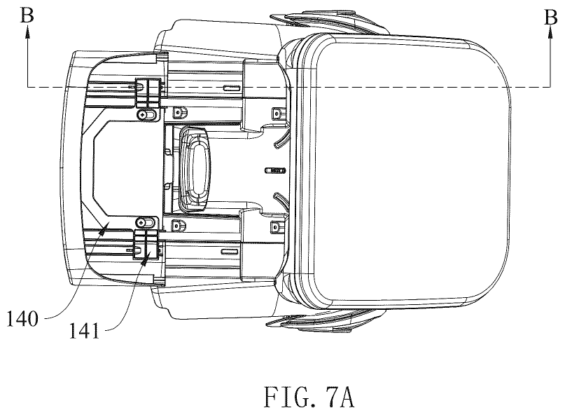

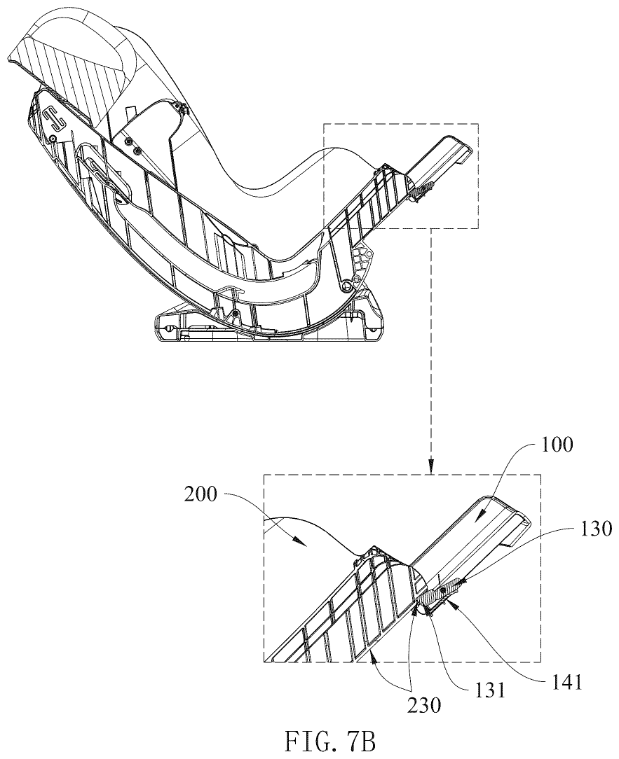

In the embodiment shown in FIG. 7B, the second locking element 230 is a positioning hole disposed on the lower surface of the seat part 200.

When the strip served as the first locking element 130 is in the locking position, the engaging end 131 may pass through the support plate body 110 and protrude from the upper surface 110A of the support plate body 110 to engage with the positioning hole served as the second locking element 230 on the seat part 200, so that the support plate 100 may be positioned in this position with respect to the seat part 200. When the strip served as the first locking element 130 is in the unlocking position, the engaging end 131 may retract into the support plate body 110 and disengage from the positioning hole served as the second locking element 230 on the seat part 200, and at this moment, the support plate 100 may be freely slidable with respect to the seat part 200.

It should be understood that a plurality of positioning holes served as the second locking element 230 may be provided in a front and rear direction of the seat part 200. The engaging end 131 of the strip served as the first locking element 130 are engaged with different positioning holes, the support plate 100 may be positioned at different positions with respect to the seat part 200 so that it can be used in different vehicle models.

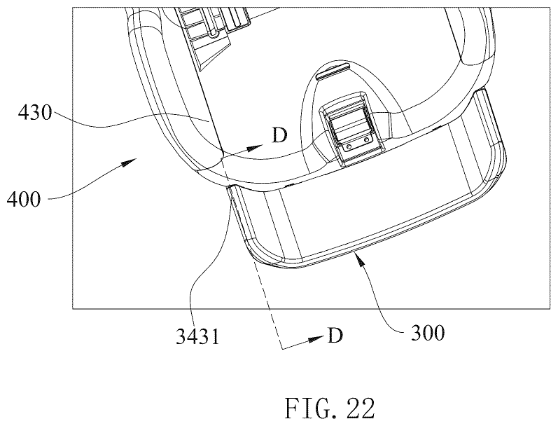

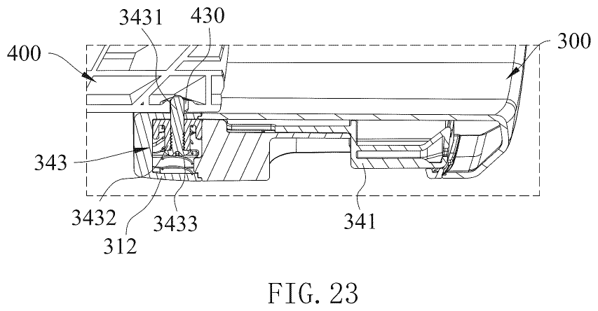

Of course, the present disclosure may not be limited thereto. According to the present disclosure, the first locking element 130 of the support plate 100 and the second locking element 230 on the seat part 200 may adopt other cooperating structures, as long as these cooperating structures can realize the locking and unlocking of the support plate 100 with respect to the seat part 200. For example, the first locking element 130 may be a positioning hole disposed on the support plate body 110 of the support plate 100, and the second locking element 230 may be a strip disposed on the seat part 200. Alternatively, the first locking element 130 may be a positioning pin disposed to the support plate body 110 of the support plate 100, and the second locking element 230 may be a positioning slot disposed on the seat part 200. In addition, the “positioning structure” (corresponding to the first locking element 130 in this embodiment) configured to position the seat part to the base may also refer to an assembly including a plurality of elements or parts or components, rather than a single component, reference can be made to the positioning structure 343 shown in the subsequent embodiments of FIGS. 22 and 23, but the present disclosure may not be limited thereto.

In order to facilitate the user to operate the engagement and disengagement between the first locking element 130 of the support plate 100 and the second locking element 230 on the seat part 200, the support plate 100 according to the present disclosure may further include an operating element 140. The operating element 140 is disposed to the support plate body 110 and may be operated by a user to drive the movement of the first locking element 130 between the locking position and the unlocking position. When the operating element 140 is operated by the user to drive the movement of the first locking element 130 between the locking position and the unlocking position, the first locking element 130 of the support plate 100 disengages from the second locking element 230 on the seat part 200. When the operating element 140 is operated by the user to drive the movement of the first locking element 130 between the unlocking position and the locking position, the first locking element 130 of the support plate 100 engages with the second locking element 230 on the seat part 200.

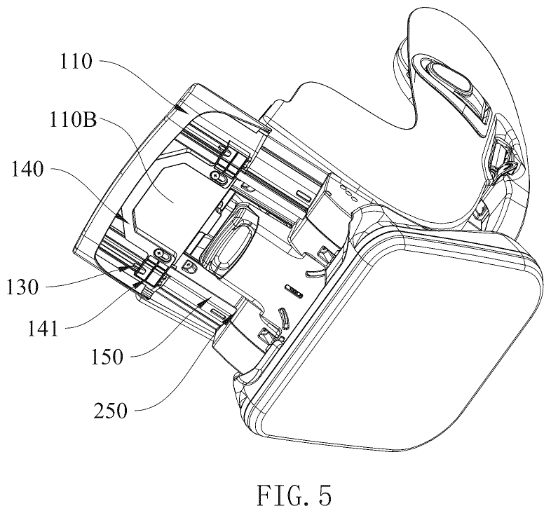

In the embodiment shown in FIG. 5, the operating element 140 is a slidable handle disposed on the lower surface 110B of the support plate body 110. For example, the handle may be provided with a sliding slot in cooperation with the connecting tube 150, so that the handle may be slidable along the connecting tube 150. Specifically, the two ends of the operating element 140 may be socketed on each of the two connecting tube 150, so as to be able to slide in the direction of extension of the connecting tube 150. A pushing rib 141 is provided on the handle. As it is required to adjust the support plate 100, the user pulls the handle served as the operating element 140, and the pushing rib 141 on the handle may push the first locking element 130 to move from the locking position to the unlocking position, so that the first locking element of the support plate 100 130 disengages from the second locking element 230 on the seat part 200, and the support plate 100 may be adjusted with respect to the seat part 200. Specifically, in one example, the pushing rib 141 has a guiding bevel that enables the guiding bevel of the pushing rib 141 to move against the first locking element 130 from the locked position to the unlocked position when the operating element 140 is operated to slide relative to the connecting tube 150. For example, the guiding bevel of the top pushing rib 141 can be pressed against an end of the first locking element 130 opposite the engaging end 131 such that the first locking element 130 (such as a bar) is pivoted to drive the engaging end 131 out of engagement with the second locking element 230 (such as a locating hole).

Of course, the operating element 140 according to the present disclosure may also employ other structures, as long as it can drive the movement of the first locking element 130. For example, the operating element 140 may be a button or an operating rod, and the user drives the movement of the first locking element 130 between the locking position and the unlocking position by pressing the button or pulling the operating rod.

In order to operate the operating element 140 easily, in the embodiment shown in FIG. 6, the support plate 100 may further include an elastic element 160 disposed to bias the first locking element 130 towards the locking position. In the embodiment shown in FIG. 6, the elastic element 160 may be a torsion spring disposed at a pivot shaft of the strip served as the first locking element 130, and the torsion spring may pivot the strip served as the first locking element 130, so that the engaging end 131 thereof may pass through the support plate body 110 and protrude from the upper surface 110A of the support plate body 110 to engage with the positioning hole served as the second locking element 230 on the seat part 200. The elastic element 160 may be configured such that the user may only need to operate the operating element 140 to resist an elastic force of the elastic element 160 and drive the movement of the first locking element 130 from the locking position to the unlocking position, and the engaging end 131 may retract into the support plate body 110, such that the disengagement between the first locking element 130 of the support plate 100 and the second locking element 230 on the seat part 200 can be implemented. Once the user no longer applies a force on the operating element 140, the elastic element 160 will bias the first locking element 130 to move from the unlocking position to the locking position. In this way, it is convenient for the operation of the user, and the structure of the operating element 140 can be simplified as it is unnecessary for the operating element to drive the movement of the first locking element 130 from the unlocking position to the locking position.

It should be understood that the elastic element 160 in the present disclosure may also adopt various elastic structures such as a compression spring, a tension spring, a hydraulic rod or a pneumatic rod, as long as the first locking element 130 may be biased towards the locking position.

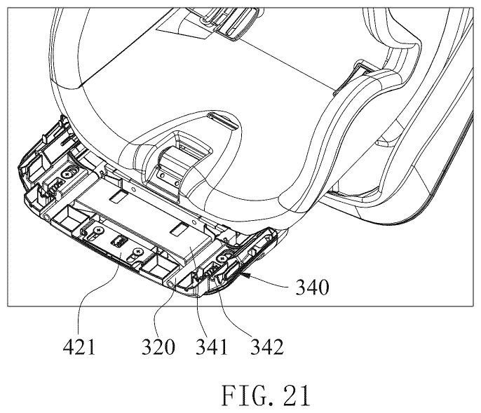

It can be understood that, in the embodiments as described above in combination with FIGS. 4 to 7B, the first locking element 130 included in the support plate 100, optionally, the operating element 140 and the elastic element 160 may be configured as a support plate adjustment mechanism for adjusting and positioning the support plate 100 to different positions with respect to the seat part 200. Of course, the support plate adjustment mechanism may also be arranged in other different structures, for example, another support plate adjustment mechanism may be described below with reference to FIGS. 21 to 24.

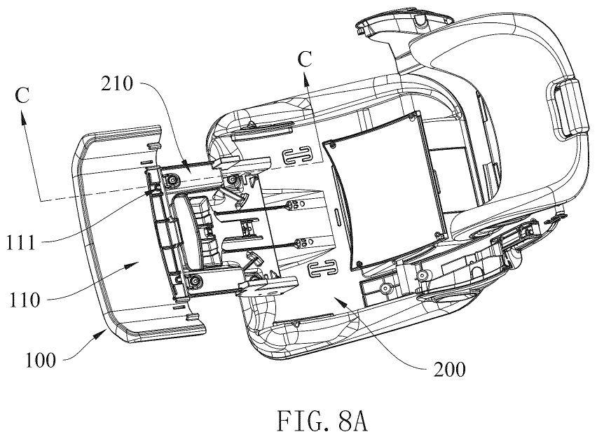

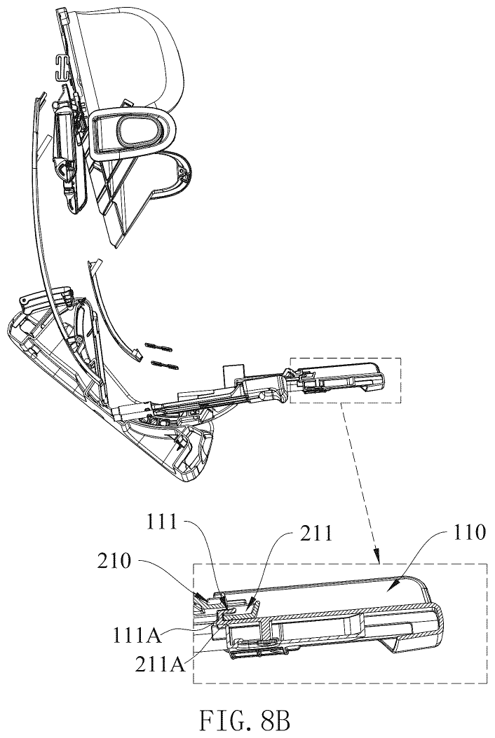

In order to prevent the support plate 100 from disengaging from the seat part 200, the support plate 100 may also be provided with a limiting mechanism, for example, the limiting mechanism may include a limiting rib and a limiting slot. Specifically, in the embodiment shown in FIGS. 8A and 8B, the support plate body 110 of the support plate 100 may also be provided with a limiting rib 111. At the same time, the seat part 200 may include a cover 210 at the front side, and the cover 210 is provided with a limiting slot 211. When the support plate 100 slides to the furthest extended position, the limiting rib 111 on the support plate body 110 may be blocked by the limiting slot 211 on the cover 210, thereby preventing the support plate 100 from continuing to slide forward and disengaging from the seat part 200. More specifically, referring to FIG. 8B, when the support plate 100 may slide to the furthest extended position, a vertical segment 111A of the limiting rib 111 may be blocked by the blocking part 211A of the limiting slot 211, so that the body of the support plate 100 may be restricted.

In addition, a child safety seat may also be provided in another embodiment of the present disclosure.

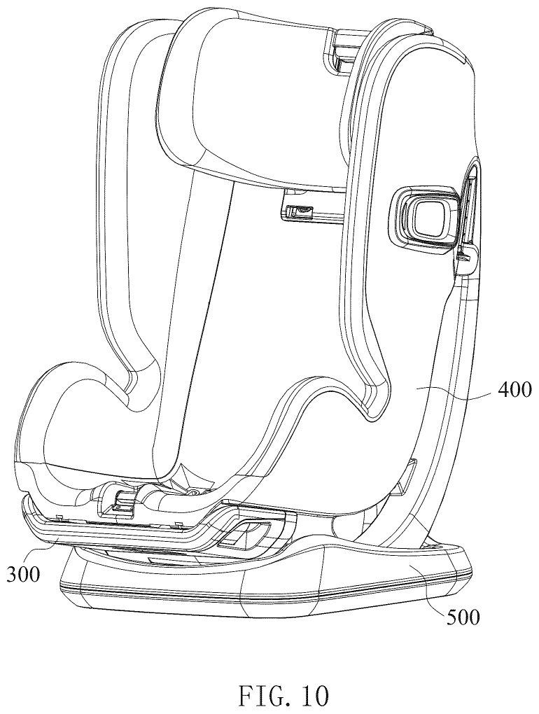

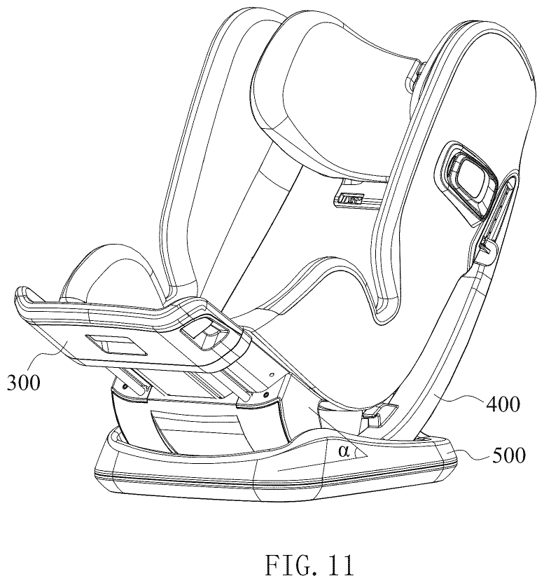

Referring to FIGS. 10 and 11, FIGS. 10 and 11 respectively show different states of the child safety seat and a support plate 300 provided thereon according to another embodiment of the present disclosure.

Specifically, the child safety seat of this embodiment may include a seat part 400 in which a child sits and a base 500 to which the seat part 400 is provided. The seat part 400 may be slidable with respect to the base 500, and may be at different angles a with respect to the base 500, wherein a is greater than or equal to 0. It should be noted that “the seat part 400 may be at the angle a with respect to the base 500” as described herein refers to an angle of a plane as defined by a position of the seat part 400 in which the child sits or a bottom plane of the seat part 400 with respect to the base 500 (for example, a plane for supporting the seat part 400). For example, FIGS. 10 and 11 respectively show the seat part 400 may have two different angles with respect to the base 500, that is, the seat part 400 shown in FIG. 10 is substantially parallel to the base 500, i.e., a is substantially equal to 0; and the angle a of the seat part 400 with respect to the base 500 shown in FIG. 11 is greater than 0, for example about 30° to 40°. Of course, the present disclosure may not be limited thereto.

Similar to the embodiment shown in FIG. 1, the child safety seat according to another embodiment of the present disclosure may also be provided with a support plate 300. As shown in FIGS. 10 and 11, the support plate 300 may be slidably connected to the seat part 400 to be telescopic from the front end of the seat part 400, so that it may abut against the backrest of the vehicle seat, for example, when the child safety seat is used in a rear-facing mode, and then prevent the child safety seat from being overturned; and at the same time, the support plate 300 may also provide support for legs of the child sitting on the seat part 400. For example, the support plate 300 of this embodiment may be slidable and may be positioned between the retracted position shown in FIG. 10 and the extended position shown in FIG. 11. Hereinafter, the specific structure and arrangement of the support plate 300 in this embodiment will be described in detail in the description of FIGS. 14 to 19.

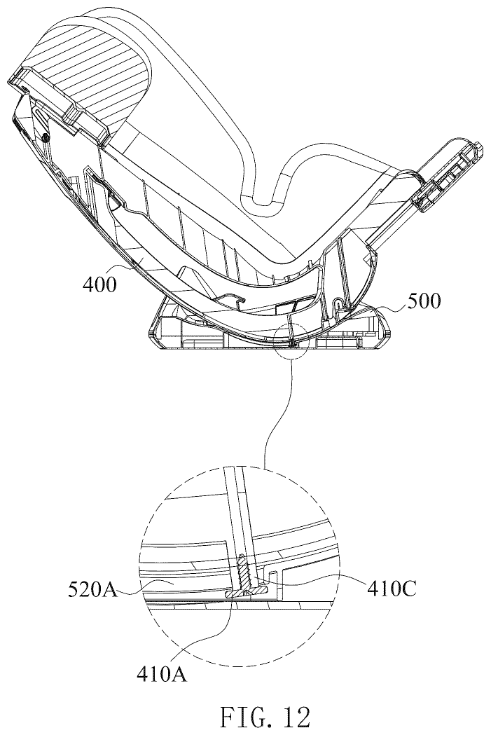

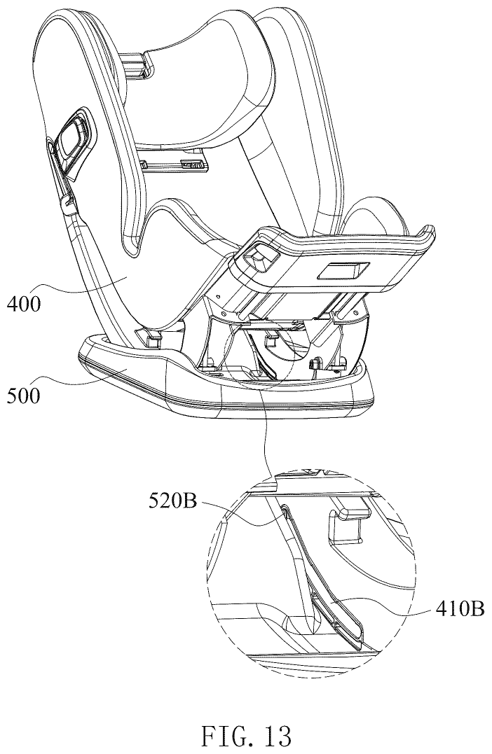

Referring to FIGS. 12 and 13, FIG. 12 shows a side cross-sectional view of the child safety seat shown in FIG. 11, and FIG. 13 shows a perspective view of the child safety seat viewed from another angle.

The seat part 400 and the base 500 of the child safety seat of the present disclosure may be slidable to each other. Specifically, the seat part 400 and the base 500 can be slidably connected through components cooperated with each other. For example, FIG. 12 shows a sliding connection between the seat part 400 and the base 500 according to an example, and FIG. 13 shows a sliding connection between the seat part 400 and the base 500 according to another example.

As shown in FIGS. 12 and 13, the seat part 400 is slidably connected with the base 500 through at least one sliding assembly. Each of the sliding assemblies may include sliding members 410A, 410B and sliding-fit members 520A, 520B. The sliding members 410A, 410B may be provided to the seat part 400. The sliding-fit members 520A, 520B may be disposed to the base 500 and slidingly fit to the sliding members 410A, 410B, respectively.

In an example, as shown in FIG. 12, the sliding member 410A is a screw fixed to the bottom of the seat part 400 through a connecting column 410C, and the sliding-fit member 520A may be an arc-shaped elongated slot extending on the upper surface of the base 500 along a direction in which the seat part 400 slides with respect to the base 500. In a preferred example, at least one arc-shaped elongated slot may be provided on the bottom side of the seat part 400. At least one arc-shaped elongated slot may be provided at the bottom side of the seat part 400, at the bottom surface of the seat part 400 in contact with the base 500, and a combination of at least one connecting column and at least one screw may be correspondingly provided on the upper surface of the base 500. Specifically, a connecting column 410C (such as a columnar structure with a threaded hole) may be fixedly arranged on the bottom side of the seat part 400. The connecting column 410C may extend into the arc-shaped elongated slot of the base 500, and the screw is connected with the connecting column 410C so that the screw, together with the connecting column 410C, may slide along the arc-shaped elongated slot, such that the sliding connection between the seat part 400 and the base 500 can be realized. Preferably, a diameter of a head of the screw is greater than a width of the arc-shaped elongated slot on the upper surface of the base 500, and optionally, a cross-sectional shape of the arc-shaped elongated slot may be adapted to a cross-sectional shape of the screw and the connecting column 410C, such as an inverted T shape, so that the seat part 400 may be slidably connected to the base 500 without being disengaged in a direction perpendicular to a sliding direction thereof. That is, during the seat part 400 is slidable with respect to the base 500, the screw and connecting column may not disengage from the arc-shaped elongated slot. It should be noted that the present disclosure is not limited to the number of arc-shaped elongated slots, connecting columns and screws as mentioned above or as shown in the figures, two or more arc-shaped elongated slots may also be provided, and a corresponding number of connecting columns and screws may be provided correspondingly. In addition, in other examples, the connecting columns and screws may also be provided on the base 500, while the arc-shaped elongated slots may be provided on the seat part 400. Furthermore, the present disclosure may only provide the connecting column 410C (i.e., without a screw), and the shape of the connecting column 410C may be a hollow cylinder, cuboid, trapezoid, etc., but the present disclosure may not be limited thereto.

In another example, as shown in FIG. 13, the sliding member 410B may be an arc-shaped sliding slot provided on a bottom side surface of the seat part 400, and the sliding-fit member 520B may be an inserting pin correspondingly provided on the base 500. Preferably, at least two arc-shaped sliding slots may be provided on the side surface of the seat part 400 in contact with the base 500, and at least two inserting pines may be correspondingly provided on the base 500. For example, an arc-shaped sliding slot may be provided on each of two inside surfaces of the seat part 400, and an inserting pin may be correspondingly provided at a position of the base 500 in matched with the inside surface of the seat part 400. Of course, the present disclosure may not be limited thereto. In other examples, positions of the arc-shaped sliding slot and the inserting pin may be interchanged, that is, the arc-shaped sliding slot may be provided on the base 500, and the inserting pin may be provided on the seat part 400. Optionally, a single inserting pin may be provided on the seat part 400, and two ends of the single inserting pin may be exposed to both sides of the seat part 400, and cooperate with the arc-shaped sliding slots of the base 500, respectively.

It should be noted that both of the sliding member 410A and the sliding-fit member 520A and the sliding member 410B and the sliding-fit member 520B of the above-mentioned two examples may be provided at the same time, to further increase the stability of the sliding connection between the seat part and the base. Of course, the present disclosure may not be limited thereto, and other sliding connection manners may also be adopted or combined.

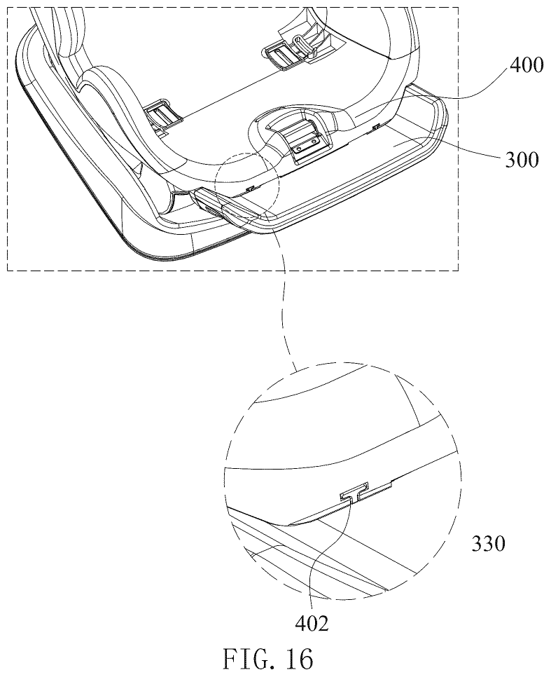

Referring to FIGS. 14 to 16, FIG. 14 shows the child safety seat according to another embodiment of the present disclosure viewed from another different angle, FIG. 15 shows a structural schematic view of the support plate 300, and FIG. 16 shows a partial perspective view of the child safety seat, showing a connection manner between the seat part 400 and the support plate 300.

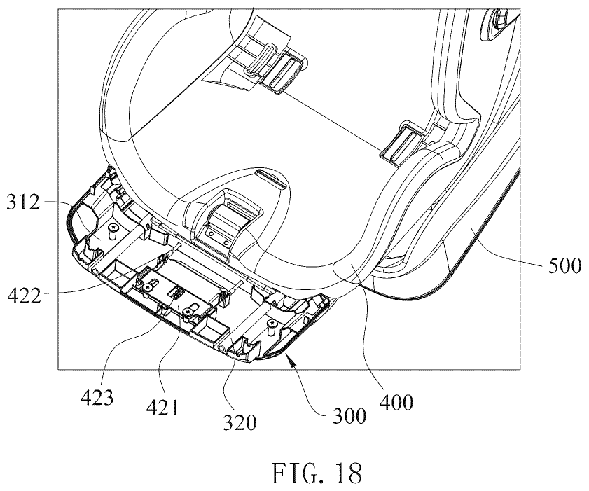

As shown in FIG. 14, the support plate 300 may be slidably provided on the seat part 400, and may be extended and retracted from the front end of the seat part 400. Further referring to FIGS. 14 and 15, the support plate 300 may include a body 310 and a first connecting element 320. In an example, the body 310 of the support plate 300 may be formed by connecting an upper cover 311, a lower cover 312 and a bottom plate 313, wherein the upper cover 311 and the lower cover 312 may form a part of the support plate 300 exposed from the seat part 400, and the bottom plate 313 may be connected to a rear end of the upper cover 311 and a rear end of the lower cover 312 and located therebetween. In an example, the bottom plate 313 may have an extension 313a extending rearwards by a certain length from a shell formed by the upper cover 311 and the lower cover 312, which can facilitate enhancing the stability of the support plate 300 when sliding with respect to the seat part 400. In an example, two first connecting elements 320 may be provided, wherein the two first connecting elements 320 may be symmetrically arranged on left and right sides of the body 310, and the extension 313a may be located between the two first connecting elements 320. Preferably, the extension 313a may be a sheet structure. At least a portion of the connecting element 320 may be fixed on the body 310, and the other part thereof may extend from the body 310 to be slidably inserted into a connecting hole 401 which is correspondingly provided on the seat part 400 and has a complementary shape, so that the support plate 300 may be slidably connected to seat part 400. In an example, as shown in FIG. 15, a length of the extension 313a may be less than a length of the connecting element 320 extending from the body 310 (for example, from the shell formed by the upper cover 311 and the lower cover 312). More specifically, at least a portion of the connecting element 320 may be fixedly connected to the bottom plate 313 of the support plate 300 by a rivet, and the specific connection between the connecting element 320 and the body 310 may be not shown in FIGS. 14 to 16 since the cover of the support plate 300 is blocked, please refer to the subsequent FIG. 18.

In addition, the connecting element 320 in this embodiment may be in a shape of a circular tube, a square tube, a circular rod, or a square rod, etc., and the present disclosure is not limited to the above embodiments, and there may be one, three or more than three connecting elements.

In an example, as shown in FIGS. 15 and 16, the support plate 300 further includes a second connecting element 330 slidingly fit to a sliding element 402 provided on the seat part 400 correspondingly, to further enhance the sliding connection between the support plate 300 and the seat part 400. In a preferred example, the second connecting element 330 may be disposed on the upper surface of the support plate 300, and more specifically on the body 310 of the support plate 300. More preferably, as shown in FIG. 16, one of the second connecting element 330 and the sliding element 402 is a sliding rib, such as a T-shaped or L-shaped sliding rib or the like, and the other one of the second connecting element 330 and the sliding element 402 is a sliding slot, such as a T-shaped or L-shaped sliding slot or the like. In addition, the second connecting element 330 and the sliding element 402 may also adopt other sliding-fit structures, such as a sliding rod and a sliding ring, as long as the support plate 300 may be slidable with respect to the seat part 400. In addition, although only two first sliding elements 330 in this embodiment are shown in FIG. 15, it should be understood for those skilled in the art that other numbers, such as one, three, four of the first sliding elements 330 may also be provided. It should be noted that the second connecting element 330 may be configured such that the support plate 300 can never protrude from the seat part 400 in order to avoid interfering with or catching clothes of the children during the support plate 300 is slidable with respect to the seat part 400.

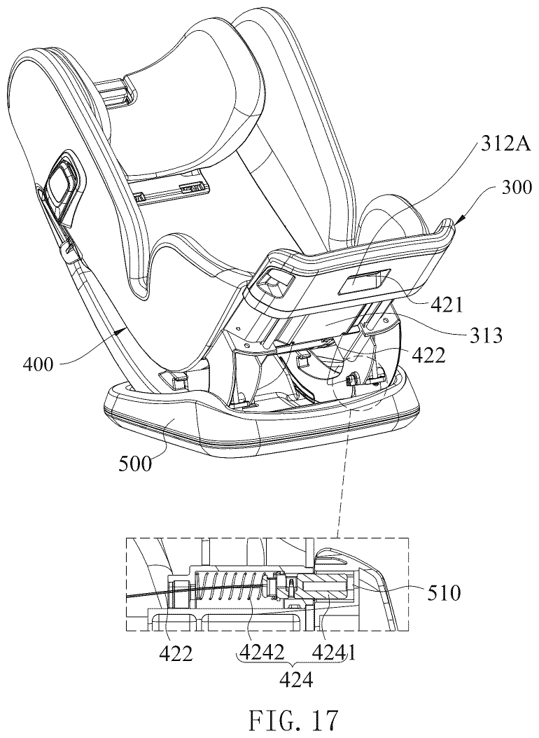

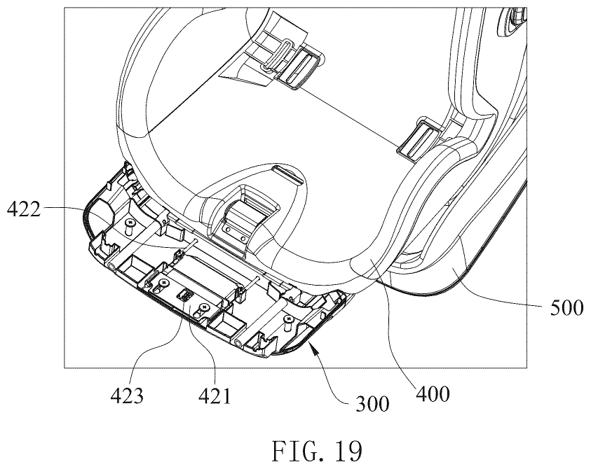

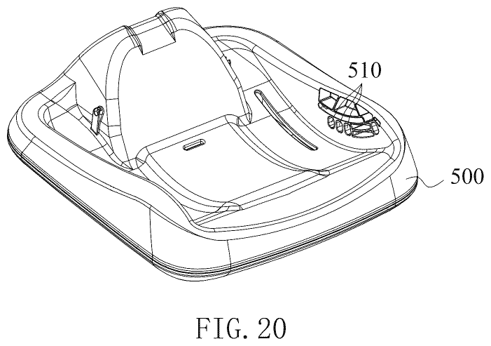

Referring to FIGS. 17 to 20, FIG. 17 shows a perspective view of the child safety seat according to another aspect of the present disclosure, in which a bottom cover plate between the support plate 300 and the seat part 400 is removed; FIGS. 18 and 19 respectively show a partial perspective view of the child safety seat viewed from above, in which the upper cover 311 of the support plate 300 is removed to show the internal structure of the support plate 300, more specifically, FIG. 18 shows that an unlocking operating member 421 of a seat angle adjustment mechanism is in a locking position, and FIG. 19 shows that the unlocking operating member 421 of the seat angle adjustment mechanism is in an unlocking position; and FIG. 20 shows the base 500 provided with a locking hole 510 in matched with a seat angle adjustment mechanism.

In order to increase comfort of the child safety seat, the child safety seat may also be provided with a seat angle adjustment mechanism, that is, a mechanism capable of adjusting an angle of the seat part 400 of the child safety seat with respect to the base 500. Specifically, the seat angle adjustment mechanism may be provided between the seat part 400 and the base 500 to adjust the angle, such as an angle a shown in FIG. 11 of the seat part 400 with respect to the base 500.

As shown in FIGS. 17 to 19, the seat angle adjustment mechanism may include an unlocking operating member 421, a connecting member 422 and an angle locking structure 424. The unlocking operating member 421 may be disposed on the support plate 300 connected to the front end of the seat part 400, and may be operated to move between an unlocking position (as shown in FIG. 19) and a locking position (as shown in FIG. 18). In an example, the unlocking operating member 421 may be slidably disposed on the support plate 300, and at least partially exposed from the support plate 300 in order to be operated from the outside. More specifically, as shown in FIG. 17, the unlocking operating member 421 is disposed on a lower side of the front end of the support plate 300, and at least partially exposed from the lower side of the support plate 300. For example, the lower cover 312 of the support plate 300 may be provided with a window 312A at a position corresponding to the unlocking operating member 421, and the user can operate the unlocking operating member 421 from the window 312A to avoid interference or misoperation caused by the unlocking operating member 421 protruding from the lower side of the support plate 300. In addition, the unlocking operating member 421 of the present disclosure may be not limited to the above-mentioned positions, that is, it may also be disposed at other positions of the support plate 300, such as any sides or upper surfaces of the support plate 300, and optionally, although only one unlocking operating member 421 is shown in FIG. 17, it should be understood that a plurality of unlocking operating members 421 may also be provided. For example, one unlocking operating member 421 may be provided on each of both sides of the support plate 300, and any one of unlocking operating members 421 may be operated to adjust the angle locking structure 424, and even adjust a plurality of angle locking structures 424 synchronously.

The connecting member 422 may be connected between the unlocking operating member 421 and the angle locking structure 424, and the angle locking structure 424 may be disposed between the seat part 400 and the base 500 to lock or unlock the seat part 400 with respect to the base 500. Referring to FIGS. 17 and 18, one end of the connecting member 422 may be fixedly connected to the unlocking operating member 421, and the other end thereof may be fixedly connected to the angle locking structure 424, so that the angle locking structure 424 may unlock the seat part 400 and the base 500 under the traction of the connecting member 422 while operating the unlocking operating member 421. In a specific example, the connecting member 422 may be a flexible element, such as a steel wire, to avoid interfering the extension and retraction of the support plate 300. More specifically, referring to a part where the bottom cover plate of the seat part 400 is removed in FIG. 17, the other end of the connecting member 422 may pass through the support plate 300 and may be connected to the angle locking structure 424.

In an example, a receiving slot 3131 for fixing the connecting member 422 may also be provided on the extension 313a (such as a sheet structure) of the bottom plate 313 of the support plate 300. The number of receiving slots 3131 corresponds to the number of connecting members 422, particularly referring to FIG. 15. For example, referring to FIGS. 15 and 17, two receiving slots 3131 may be symmetrically disposed at intervals on the extension 313a to respectively receive a corresponding connecting member 422 therein. Therefore, in addition to enhancing the sliding stability of the support plate 300, the extension 313a may also block the connecting member 422, to prevent the connecting member 422 from being interfered by external devices and make the appearance of the child safety seat neat. For example, the receiving slot 3131 may be in a U-shaped structure with an opening facing towards the seat part 400. However, the present disclosure may not be limited thereto, that is, the receiving slot 3131 may also have other shapes, as long as it can receive the connecting member 422.

In an example, a plurality of connecting members 422 and a plurality of angle locking structures 424 may be provided. In this embodiment, two connecting members 422 and two angle locking structures 424 may be taken as an example. As shown in FIG. 17, two angle locking structures 424 are respectively arranged on the inner sides of the seat part 400 facing towards each other and are located on the front side of the sliding assembly. Each of the connecting members 422 may have one end connected to one of the parts symmetrical to each other of the unlocking operating member 421 and the other end connected to one of the angle locking structures 424. More specifically, the connecting member 422 may extend from the unlocking operating member 421 through the receiving slot 3131 of the support plate 300, and then extend from the support plate 300 and connected to one end of the angle locking structure 424, in order to control the two angle locking structures 424 synchronously through the unlocking operating member 421.

In an example, as shown in FIGS. 18 and 19, the seat angle adjustment mechanism may further include a reset member 423, the reset member 423 may be disposed between the unlocking operating member 421 and the support plate 300, and constantly provide a force to make the unlocking operating member 421 in the locking position or return to the locking position.

In addition, the angle locking structure 424 may have a plurality of locking positions with respect to the base 500, so that the seat part 400 may be locked at several angles with respect to the base 500, so as to realize the angle adjustment of the child safety seat.

As shown in FIG. 17, the angle locking structure 424 may include an engaging pin 4241 which may be movably disposed on the seat part 400. Specifically, as shown in FIG. 17, one end of the engaging pin 4241 may be linked with the unlocking operating member 421 through the connecting member 422, and may be engaged with at least one engaging hole 510 provided on the base 500. Preferably, as shown in FIGS. 17 and 20, the base 500 may be provided with a plurality of engaging holes 510, so that the engaging pin 4241 may be engaged with one of the engaging holes 510 provided on the base 500 with the variation of angles of the seat part 400 relative to the base 500. It should be noted that only three engaging holes 510 are shown in FIG. 20, but the present disclosure may not be limited thereto. That is, the base 500 may also be provided with further more engaging holes, such as four, five, six, etc., to provide a fine angle adjustment.

Moreover, the angle locking structure 424 may also include an engaging reset member 4242 that may be disposed between the seat part 400 and the engaging pin 4241 to bias the engaging pin 4241 towards the corresponding engaging hole 51, that is, constantly providing a force to allow the engaging pin 4241 to engage with the corresponding engaging hole 510.

It should be noted that although the seat angle adjustment structure in this embodiment may be disposed to fit to the support plate 300, the present disclosure may not be limited thereto, and the seat angle adjustment structure may also be fit to that in the embodiment described above in combination with FIGS. 4 to 7B, that is, the unlocking operating member 421 of the seat angle adjustment structure may also be disposed on the support plate 100 in the foregoing embodiments, for example, on its front end, either side, or the like. In addition, it should also be understood that the seat angle adjustment structure may also be used in cooperation with a non-adjustable support plate, that is, the unlocking operating member 421 of the seat angle adjustment structure may be disposed on a seat with the non-adjustable support plate. Such configuration can also facilitate the user not to be blocked by the support plate 300 when it is required to operate the unlocking operating member 421 to adjust an angle of the seat.

The principle of the seat angle adjustment mechanism will be specifically described below by taking the angle locking structure 424 shown in FIGS. 17 to 19 as an example.

Prior to adjusting the angle of the seat, as shown in FIGS. 17 and 18, the unlocking operating member 421 may be in the locking position, the seat part 400 may be positioned with respect to the base 500, and the engaging pin 4241 of the angle locking structure 424 may be engaged with the engaging hole 510 on the base 500 under the elastic action of the engaging reset member 4242.

When the adjustment of the angle of the seat is required, the user may operate the unlocking operating member 421 to the unlocking position (as shown in FIG. 17) in a direction of resisting the reset member 423, for example, by pressing the unlocking operating member 421 from the window 213A (see FIG. 17) on the support plate 300 to pull the connecting member 422, so that the engaging pin 4241 can resist the elastic effect of the engaging reset member 4242 to disengage from the engaging hole 510 under the traction of the connecting member 422. At this time, the seat part 400 may be unlocked from the base 500 and may be slidable with respect to the base 500 so as to be adjusted to a desired angle.

When the seat may be adjusted to the desired angle, the user may release the unlocking operating member 421, the unlocking operating member 421 may return to the locking position as shown in FIG. 18 under the elastic action of the reset member 423, and the engaging pin 4241 may return to an engaging position as shown in FIG. 17 under the elastic action of the engaging reset member 4242. Preferably, an elastic force of the engaging reset member 4242 may be greater than an elastic force of the reset member 423, so that the connecting member 422 can always be maintained in a tensioned state.

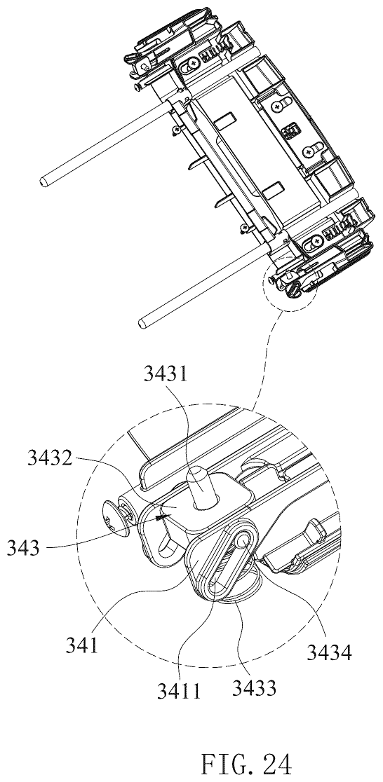

Referring to FIGS. 21 to 24, FIG. 21 shows another partial perspective view of the child safety seat according to another embodiment of the present disclosure, in which the upper cover 311 of the support plate 300 is removed to show the internal structure of the support plate 300; FIG. 22 shows a top partial perspective view of the support plate 300 and the seat part 400; FIG. 23 shows a cross-sectional view taken along a line “D-D” in FIG. 22; and FIG. 24 shows a perspective view of the support plate 300, in which the upper cover 311 and the bottom plate 313 are removed.

In order to further improve the comfort of the child safety seat, adapt to different vehicle models better, and provide support for different legs of children, a support plate adjustment mechanism 340 may also be provided on the support plate 300 to adjust a telescopic position of the support plate 300 with respect to the seat part 400, that is, adjust a length of the support plate 300 extending from the seat part 400.

In an example, the support plate adjustment mechanism 340 may include an operating element 341 and a positioning structure 343. For ease of understanding, FIG. 21 mainly shows the structure of the operating element 341 without the positioning structure 343, FIG. 22 shows the positioning method between the support plate 300 and the seat part 400, and FIGS. 23 and 24 show connection and cooperation between the positioning structure 343 and the operating element 341.

As shown in FIG. 21, the operating element 341 may be slidably disposed on the support plate 300, and may be slidable between a locking position (see FIG. 21) and a releasing position (not shown). Referring to FIG. 14, the operating element 341 may be at least partially exposed from the support plate 300. For example, the operating element 341 may be configured as a member spanning the inside of the support plate 300 and having left and right ends respectively exposed to both sides of the support plate 300, to form an adjusting end on either side of the support plate 300. Thus, the user can operate the operating element 341 through the adjusting end on either side of the support plate 300. Similarly, a window may also be provided on either side of the support plate 300, to prevent unnecessary interference caused by the two adjusting ends protruding from the outer surface of the support plate 300. It should be noted that the operating structure of the present disclosure is not limited to the above-described structure, but may also be constructed as two separate members disposed on both sides of the support plate 300 and synchronised for movement of the two by means of a connecting structure, but the present disclosure is not limited thereto.

In an example, the support plate adjustment mechanism 340 may further include an elastic element 342. The elastic element 342 may be disposed between the operating element 341 and the support plate 300 to bias the operating element 341 towards the locking position, that is, constantly providing a force to allow the operating element 341 be at or return to the locking position. More specifically, one end of the elastic element 342 may abut against the operating element 341, and the other end thereof may abut against the inner side of the lower cover 312 of the support plate 300. For example, as shown in FIG. 21, two elastic elements 342 may be symmetrically arranged on the support plate 300 in a left-right direction. More preferably, the two elastic elements 342 may be respectively arranged at left and right ends of the operating element 341 of the support plate 300, so that the operating element 341 may be stably slidable with respect to the support plate 300 until it returns to the locking position.

Further referring to FIGS. 22 to 24, the positioning structure 343 may be disposed on the support plate 300 and linked with the operating element 341 to position the support plate 300 in at least one position of the seat part 400. When the operating element 341 may be in the locking position, the positioning structure 343 may be locked, so that the support plate 300 may be positioned with respect to the seat part 400. When the operating element 341 may be operated to the releasing position (not shown), the positioning structure 343 may be operated to be unlocked, so that the support plate 300 may move with respect to the seat part 400. In this embodiment, the positioning structure 343 includes a first positioning structure and a second positioning structure disposed on both sides of the support plate 300 (the body of the support plate thereof), respectively, to be coupled with the operating element 341.

In an example, as shown in FIGS. 22 and 23, the positioning structure 343 may include a first locking element 3431, and the first locking element 3431 may be disposed at an end of the support plate 300 adjacent to the seat part 400. As the operating element 341 is movable between the locking position and the releasing position, the first locking element 3431 may be engaged with the second locking element 430 correspondingly provided on the seat part 400 (that is, the first locking element 3431 is in the locking position) or disengaged from the second locking element 430 (that is, the first locking element 3431 is in the unlocking position). In this embodiment, as an example, the first locking element 3431 may be configured as a positioning pin and the second locking element 430 may be configured as a positioning slot. More specifically, two positioning slots are shown in FIG. 22, but the present disclosure may not be limited thereto, more positioning slots may also be provided to provide fine position adjustment.

More specifically, as shown in FIGS. 23 and 24, the first locking element 3431 may be fixedly disposed on a fixing seat 3432 at the end of the support plate 300, and the operating element 341 may be provided with an inclined slot 3435 that may be slidingly fit to the fixing seat 3432. The Inclined Slot 3411 may slope downwardly in the direction of retraction of the support plate 300 (as shown in FIG. 24), but the present disclosure is not limited thereto. For example, the inclined slot 3435 may be located at one end of the operating element 341, such as an end opposite to an operated end (i.e., an end exposed from the support plate 300) as shown in FIG. 23, and may be slidably connected to the fixing seat 3432 through linkage pins 3434 provided at both sides of the fixing seat 3432. In an example, the linkage pin 3434 may be integrally formed with the fixing seat 3432, and protrude from either side of the fixing seat 3432. However, the present disclosure may not be limited thereto. For example, in other embodiments, the linkage pin 3434 may also be a pin that may be inserted into the fixing seat 3432 and protrude from either side of the fixing seat 3432.

It can be seen from FIG. 24 that when the operating element 341 is operated to move from the locking position to the releasing position (not shown), the operating element 341 may drive the inclined slot 3435 at an end thereof to move forward, and then the fixing seat 3432 may move downward along with the movement of the linkage pin 3434 in the inclined slot 3435, thereby driving the first locking element 3431 to disengage from the seat part 400. At this time, the support plate 300 may be slidable with respect to the seat part 400.

In an example, a return spring 3433 may also be provided between the fixing seat 3432 and the support plate 300 (such as the lower cover 312 of the support plate 300) to assist the first locking element 3431 to maintain or return to a position engaged with the seat part 400.

By adjusting the length of the support plate 300 protruding from the seat part 400, the support plate 300 may abut against a backrest in any different vehicles, to make the connection of the child safety seat more firm; in addition, by adjusting the length of the support plate 300 protruding from the seat part 400, different leg spaces for children sitting on the seat part 400 can be provided to satisfy the children in different heights.

The present disclosure has beneficial effects as follows: the seat angle adjustment mechanism may be provided on the child safety seat to adjust an angle of the seat, that is, an angle of the seat part with respect to the base, so as to improve the comfort of the child safety seat. At the same time, the unlocking operating member of the seat angle adjustment mechanism may be disposed on the support plate, so that the operation of the seat angle adjustment mechanism can be convenient and cannot be interfered by the extension and retraction of the support plate, thereby improving the convenience of the seat angle operation, and further improving user's satisfaction. In addition, such a seat angle adjustment mechanism has a simple structure, is convenient for production and processing, and has low cost. Thus, the present disclosure can solve a problem of the seat angle adjustment mechanism in the prior art, that is, since operation buttons are generally provided at the front end of the seat, when the support plate protrudes from the front end of the seat, the seat angle adjustment button will be shield and difficult to be found, or the user's hand can be blocked to touch the button to cause inconvenience.

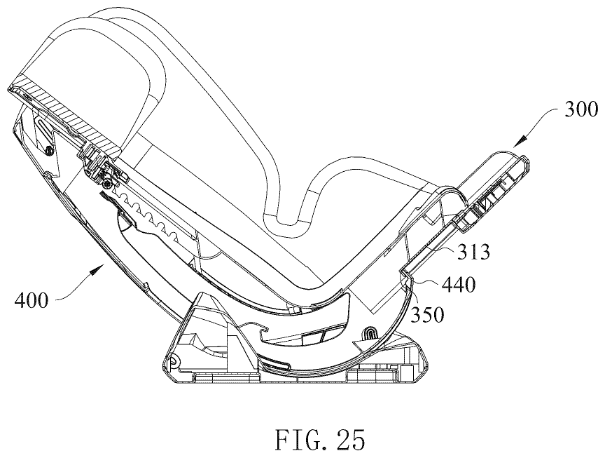

Referring to FIG. 25, another side cross-sectional view of the child safety seat according to another aspect of the present disclosure is shown. In order to prevent the support plate 100 from disengaging from the seat part 200, a limiting mechanism may also be provided on the support plate 300, for example, the limiting mechanism may be composed of two limiting pieces. Specifically, as shown in FIG. 25, the support plate 300 may also be provided with a first limiting piece 350, and the seat part 400 may be correspondingly provided with a second limiting piece 440. Specifically, the first limiting piece 350 may be disposed on the bottom plate 313. For example, the first limiting piece 350 may fixed to one end (which is opposite to an end protruding from the seat part 400) of the support plate 300 and extend by a certain distance along a direction perpendicular to the support plate 300 from the end thereof. Through the cooperation of the first limiting piece 350 and the second limiting piece 440, a stroke of the support plate 300 extending from the seat part 400 can be limited and is less than or equal to a distance by which one end of the support plate 300 extends.

Specifically, it can be seen from FIG. 25 that when the support plate 300 is pulled forward under the seat part 400, the first limiting piece 350 moves forward along with the support plate 300, until it abuts against the second limiting piece 440, to limit the further movement of the support plate 300 and thus prevent the support plate 300 from being separated from the seat part 400.

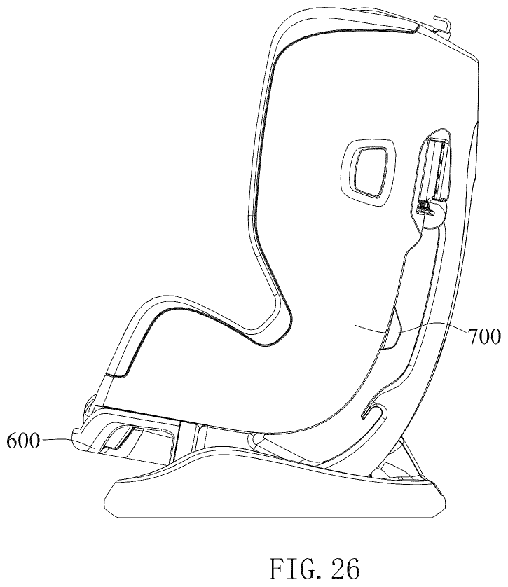

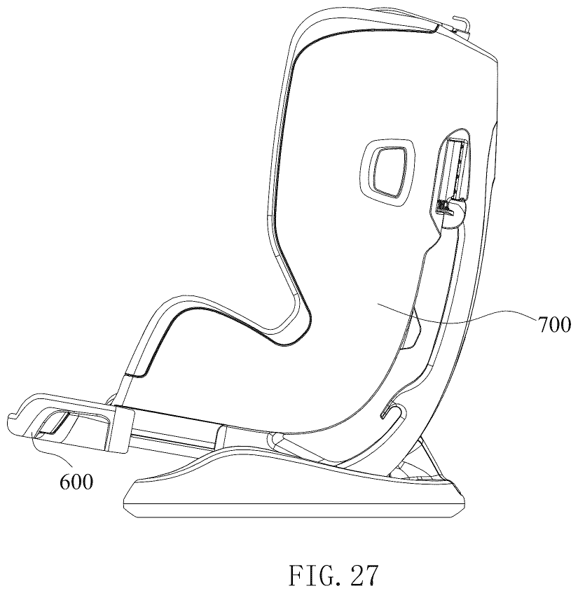

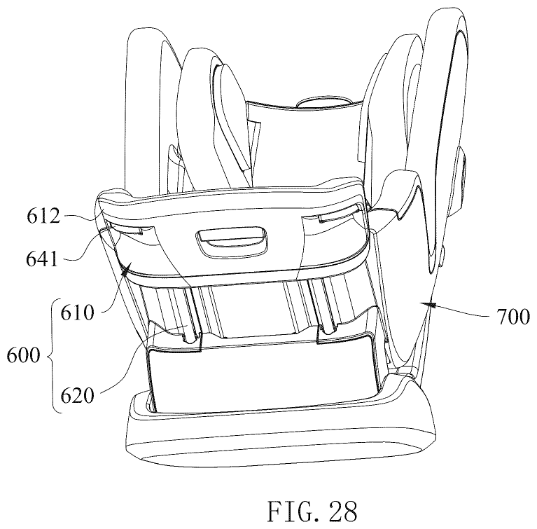

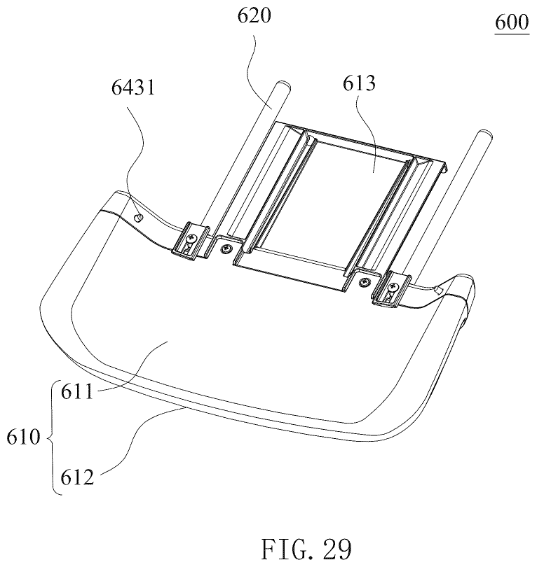

In addition, another embodiment of the present disclosure also provides a child safety seat and a support plate 600 for the child safety seat. FIGS. 26 and 27 show the child safety seat in which the support plate 600 is in different states. The child safety seat of this embodiment may include a seat part 700 for a child to sit thereon and a support plate 600 slidably connected to the seat part 700. FIG. 28 shows a perspective view of the child safety seat of this embodiment from another angle. FIG. 29 shows a perspective view of the support plate 600. It should be noted that orientations or directions such as “front” and “rear” described below are defined based on a position of the support plate 600 with respect to the seat part 700. Specifically, “front” refers to a direction in which the support plate 600 protrudes from the seat part 700, that is, a “front end” of the support plate 600 is an end away from the seat part 700 when the support plate 600 protrudes therefrom; and “rear” refers to a direction in which the support plate 600 retracts towards the seat part 700, that is, a “rear end” of the support plate 600 is an end close to the seat part 700 when the support plate 600 protrudes therefrom.

As shown in FIGS. 26 to 28, the support plate 600 is slidable with respect to the seat part 700 and extends from a front end of the seat part 700. The support plate 600 includes a support plate body 610 and a first connecting element 620, wherein the support plate body 610 may include an upper cover 611 and a lower cover 612, and optionally a bottom plate 613. The upper cover 611 and the lower cover 612 form a part of the support plate 600 exposed from the seat part 700. Specifically, the support plate 600 may have other specific structures similar to those of the support plate 300 in the previous embodiment, which will not be described in detail in this embodiment. In addition, the support plate 600 of this embodiment can also be connected with the seat part 700 through a connection mode and structure similar to that in the previous embodiment, such as the sliding assembly including sliding members 410A and 410B and the sliding-fit members 520A and 520B in the previous embodiment, and/or the second connecting element 330 and the sliding element 402, which will not be described in detail herein.

In this embodiment, the support plate 600 is slidable between a retracted position (see FIG. 26, that is, a position where the support plate 600 is completely retracted into the seat part 700) and a fully extended position (see FIG. 27). In addition to the fully extended position shown in FIG. 27 (i.e., a limit position where the support plate 600 extends outwards from the seat part 700), the support plate 600 may have a plurality of other extended positions, all of which are located between the retracted position and the fully extended position. In order to enable the support plate 600 to be adjusted and positioned at different positions with respect to the seat part 700, the support plate 600 may be provided with a support plate adjustment mechanism 640 for adjusting a telescopic position of the support plate 600 with respect to the seat part 700, that is, adjusting a length extending from the seat part 700.

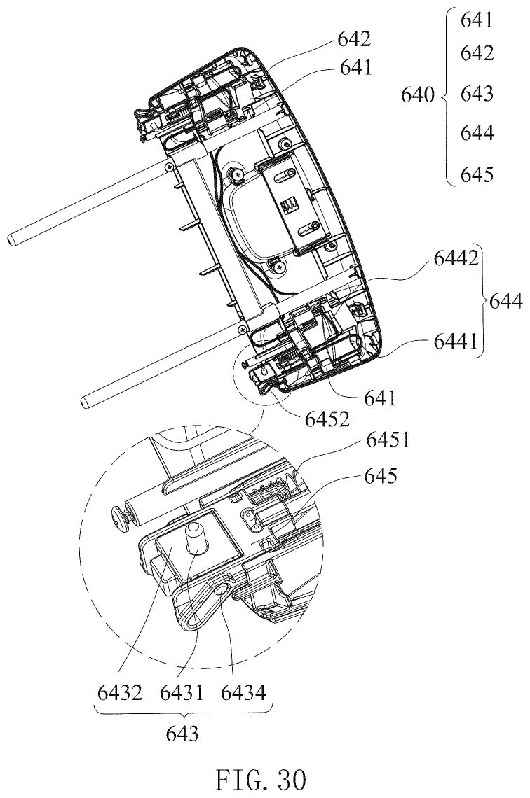

FIG. 30 shows another perspective view of the support plate 600 shown in FIG. 29, and FIG. 31 shows a partial top perspective view of the child safety seat of this embodiment, in which the upper cover 611 of the support plate 600 is removed in both FIGS. 30 and 31, so as to show an internal structure of the support plate 600 and explain a configuration of the support plate adjustment mechanism 640.

Different from the previous embodiment, the support plate adjustment mechanism 640 of this embodiment includes two operating elements 641, and a pulling element 644 and a driving element 645 corresponding to each of the operating elements 641, and a positioning structure 643 (i.e., a first positioning structure and a second positioning structure disposed on two sides of the support plate body 610 of the support plate 600), wherein the operating elements 641 and their corresponding pulling elements 644 and driving elements 645 can be collectively referred to as “operating mechanism”. The operating mechanism is at least partially movably disposed on the support plate 600, and the positioning structure 643 is linked with the operating mechanism to position the support plate 600 in at least one position of the seat part 700. Specifically, as shown in FIGS. 28, 30 and 31, the operating element 641 is slidably disposed on the support plate 600 and can slide between a locking position and a releasing position. In an example, the operating element 641 may be at least partially exposed from the support plate 600. The two operating elements 641 are respectively disposed at two sides of the support plate 600, specifically located inside the support plate body 610 of the support plate 600, and at least a part of each of the operating elements 641 is exposed from the lower cover 612 of the support plate 600, so that a user can access the operating element 641 from the outside of the support plate 600 and operate it. Optionally, as shown in FIG. 28, two sides of the lower cover 612 of the support plate 600 may be respectively provided with a recessed portion, and a window exposing the operating element 641 is provided in the recessed portion, thereby preventing the operating element 641 protruding from the support plate 600 from interfering with other components or operators.

In an example, as shown in FIG. 30, the support plate adjustment mechanism 640 may further include an elastic element 642, which is disposed between the corresponding operating element 641 and the support plate 600, and constantly provides a force to enable the corresponding operating element 641 in or to be restored to the locking position. Specifically, one end of the elastic element 642 abuts against the operating element 641, and the other end of the elastic element 642 abuts against the support plate 600, such as an inner side of the support plate body 610.

As shown in FIGS. 30 and 31, the driving element 645 is slidably disposed on the support plate 600 and can move along with the operation of the corresponding operating element 641. In an example, the driving element 645 is disposed at a rear end of the support plate 600, that is, an end opposite to the end (i.e., the front end) of the support plate 600 protruding from the seat part 700. The traction element 644 includes a first traction element 6441 and a second traction element 6442. The first traction element 6441 is configured to be connected between the operating element 641 and the driving element 645 located at the same side of the support plate 600, so that the driving element 645 is linked with the operating element 641. The second traction element 6442 is configured to be connected between the operating mechanisms on two sides, for example, between the operating element 641 on one side and the driving element 645 on the other side, so that the operating mechanisms on two sides are linked. In an example, at least one of the first traction element 6441 and the second traction element 6442 may be a flexible element, such as a steel wire.

In an example, the first traction element 6441 may include a first traction wire 6441a, and the first traction wire 6441a has a first end, a wire body portion and a second end. Specifically, the first end and the second end of the first traction wire 6441a may be fixedly connected to the operating element 641 and the driving element 645 respectively, so that when the operating element 641 is operated, the driving element 645 may be driven to move through the first traction wire 6441a.

Optionally, the first traction element 6441 may further include a first sheath 6441b, which is sleeved on the first traction wire 6441a (i.e., wraps the first traction wire 6441a) to protect the first traction wire 6441a, prevent it from being worn and prolong its service life. Specifically, two ends of the first sheath 6441b are respectively fixed to the support plate 600.

In another example, the first traction element 6441 may include a first traction wire 6441a and a first sheath 6441b. The first traction wire 6441a has a first end, a wire body portion and a second end. The first end of the first traction wire 6441a is fixedly connected to the driving element 645, and the second end of the first traction wire 6441a is fixedly connected to the support plate 600 (for example, the lower cover 612 of the support plate body 610). Optionally, the wire body potion may be movably disposed on the operating element 641, for example, it may be configured to slidably pass through the operating element 641. The first sheath 6441b is sleeved on the first traction wire 6441a, wherein the first end of the first sheath 6441b abuts against the support plate 600 (for example, the lower cover 612 of the support plate body 610), and the second end of the first sheath 6441b is connected with the operating element 641. When the operating element 641 is operated, the operating element 641 will push the first sheath 6441b. Since the first sheath 6441b abuts against the support plate 600 and thus cannot move, it will react to the first traction wire 6441a sleeved therein, so that the first traction wire 6441a drives the driving element 645 to move.

As shown in FIG. 30, the second traction element 6442 may include a second traction wire 6442a, and the second traction wire 6442a has a first end, a wire body portion and a second end. Specifically, the first end of the second traction wire 6442a is connected to the operating element 641 on one side of the support plate 600, and the second end of the second traction wire 6442a is connected to the driving element 645 on the other side of the support plate 600. In an example, the second traction element 6442 may further include a second sheath 6442b sleeved on the second traction wire 6442a to protect the second traction wire 6442a, prevent it from being worn and prolong its service life. The two ends of the second sheath 6442b are fixed to two sides of the support plate 600, that is, the first end of the second sheath 6442b is fixed to one side of the support plate 600 close to the driving element 645, and the second end of the second sheath 6442b is fixed to the other side of the support plate 600 close to the operating element 641. When the operating element 641 on one side of the support plate 600 is operated, the driving element 645 on this side is driven to move, and at the same time, the driving element 645 on the other side is driven to move through the second traction element 6442.

As shown in FIGS. 29 to 31, the positioning structure 643 is disposed on the support plate 600 and is linked with the driving element 645 (i.e., linked with the driving element 645 and the operating element 641 connected with the driving element 645 through the first traction element 6441) so as to position the support plate 600 in at least one position of the seat part 700. When the operating element 641 is in the locking position, the positioning structure 643 is in the locking position, so that the support plate 600 is positioned with respect to the seat part 700. When the operating element 641 is operated to the releasing position, it will drive the driving element 645 to move, and then drive the positioning structure 643 to be unlocked, so that the support plate 600 can move with respect to the seat part 700.

In an example, the support plate adjustment mechanism 640 may further include a driving element return spring 6451. The driving element return spring 6451 is disposed between the driving element 645 and the support plate 600, for example, two ends of the driving element return spring 6451 respectively abuts against the driving element 645 and the lower cover 612 of the support plate 600, so as to provide an elastic force to the driving element 645, so that the positioning structure 643 matched with the driving element 645 is in or restored to the locking position, and/or the operating element 641 linked with the driving element 645 is in or restored to the locking position.

In an example, as shown in FIGS. 29 and 30, the positioning structure 643 may include a first locking element 6431 disposed at an end of the support plate 600 adjacent to the seat part 700. With the movement of the operating element 641 between the locking position and the releasing position, the first locking element 6431 may be engaged with the corresponding second locking element 730 (in combination with FIG. 31) on the seat part 700, so that the first locking element 6431 is located in the locking position; or, the first locking element 6431 may be disengaged from the second locking element 730, so that the first locking element 6431 is located in the unlocking position. In this embodiment, it can be seen from FIGS. 29 to 31 that the first locking element 6431 may be configured as a positioning pin and the second locking element 730 can be correspondingly configured as a positioning groove, but the present disclosure is not limited thereto, and the first locking element 6431 and the second locking element 730 may also be configured to have other structures, such as a hook-and-loop structure, a concave-convex structure, and the like. The child safety seat of the present disclosure may be provided with one or more sets of second locking elements 730. Specifically, two sides of the seat part 700 may be respectively provided with one or more positioning grooves matched with corresponding positioning pin(s), so that the support plate 600 is positioned at one or more positions with respect to the seat part 700. Optionally, in this embodiment, a plurality of positioning grooves may be provided on each of two sides of the seat part 700 to provide more detailed position adjustment.

As shown in FIG. 30, a fixing seat 6432 is provided at an end of the support plate 600 adjacent to the seat part 700 (i.e., the rear end of the support plate 600) and may cooperate with the driving element 645. Specifically, the first locking element 6431 is fixedly disposed on the fixing seat 6432, and the corresponding driving element 645 is provided with an inclined slot 6452 which is slidably matched with the fixing seat 6432. In an example, the inclined slot 6452 is located at one end (e.g., the rear end) of the driving element 645, and is slidably connected to the fixing seat 6432 through linkage pins 6434 disposed at two sides of the fixing seat 6432. The inclined slot 6452 may be inclined downward towards the rear end of the support plate 600, but the present disclosure is not limited thereto. Specifically, the linkage pins 6434 may be integrally formed with the fixing seat 6432 and protruded on two sides of the fixing seat 6432 respectively, but the present disclosure is not limited thereto. For example, in other embodiments, the linkage pin 6434 may also be a pin inserted through the fixing seat 6432 and protruding from two sides of the fixing seat 6432.

In an example, a restoring element (not shown), such as a return spring, may be further provided between the fixing seat 6432 and the support plate 600 (e.g., the lower cover 612 of the support plate 600) to assist the first locking element 6431 to be kept in or be restored to a position where it is engaged with the seat part 700. For example, a restoring element may be disposed below the fixing seat 6432 to provide a force to move the fixing seat 6432 and the first locking element 6431 disposed thereon upward.

When the operating element 641 is operated to move from the locking position to the releasing position, the operating element 641 drives the driving element 645 to move the inclined slot 6452 at one end of the driving element 645, and the fixing seat 6432 moves downward as the linkage pin 6434 moves in the inclined slot 6452, thereby driving the first locking element 6431 to be disengaged from the seat part 700. At this time, the support plate 600 may slide with respect to the seat part 700. When the operating element 641 is released, the fixing seat 6432 and the first locking element 6431 move upwards under the action of the return spring and/or the driving element return spring, and are locked with the second locking element 730 disposed on the seat part 700, so that the support plate 600 is locked with respect to the seat part 700. At the same time, the linkage pin 6434 moves in the inclined slot 6452 to drive the driving element 645 to move, and further drive the operating element 641 to move from the releasing position to the locking position.

By providing the support plate adjustment mechanism 640 of this embodiment, when it is necessary to adjust the support plate 600, the operator may pull the operating element 641 on either side (for example, in a direction F as shown in FIG. 31), and the operating element 641 drives the driving element 645 to move through the first traction element 6441, thereby driving the positioning structure 643 (specifically, the first locking element 6431) on the same side of the operating element 641 to be unlocked. At the same time, the operating element 641 on this side drives the driving element 645 on the other side to move through the second traction element 6442, thereby unlocking the positioning structure 643 on the other side.

In addition, in other embodiments, one operating element 641 may be provided, and the operating element 641 may be connected with the first positioning structure and the second positioning structure disposed on two sides of the support plate 600 (specifically, the support plate body 610) through the first traction element and the second traction element, respectively, so as to unlock the first positioning structure and the second positioning structure by operating the operating element 641. Specifically, one end of the first traction element is connected to the operating element 641, and the other end of the first traction element is connected to the first positioning structure. One end of the second traction element is connected to the operating element 641, and the other end of the second traction element is connected to the second positioning structure. When the operating element 641 moves (e.g., slides) from the locking position to the releasing position, the first traction element pulls the first positioning structure to be unlocked, and the second traction element pulls the second positioning structure to be unlocked.

By adjusting the length of the support plate 600 protruding from the seat part 700, the support plate 600 may abut against the backrest of any of different vehicles, so as to connect the child safety seat more firmly. In addition, by adjusting the length of the support plate 600 protruding from the seat part 700, different sizes of spaces can be provided for legs of a child sitting on the child safety seat, so as to satisfy the requirements of children with different heights.

In addition, generally, a baby vehicle seat (also referred to as “child safety seat” or “child carrier”) includes a base and a carrier body detachably mounted on the base. The base may be connected with an interface on the vehicle seat through an ISO fixing device (ISOFIX) disposed at a rear end of the base. A carrier body is provided with a headrest having an adjustable height, and the height of the headrest is adjusted to adapt to a height of a baby to ensure the use safety and comfort of the baby.

Generally, the carrier body is provided with a height adjustment apparatus for the headrest to adjust its height, and correspondingly, the headrest is provided with a locking element matched with the height adjustment apparatus, and the headrest may be adjusted vertically with respect to the carrier body to realize the height adjustment of the headrest, and the headrest may be locked at a target height by the cooperation between the locking element and the height adjustment apparatus. However, when an emergency braking occurs during the driving of the vehicle at a high speed, the headrest is prone to be accidentally unlocked due to the inertia, causing that the headrest cannot effectively protect a head of the baby and thus easily causing injuries to the head of the baby.

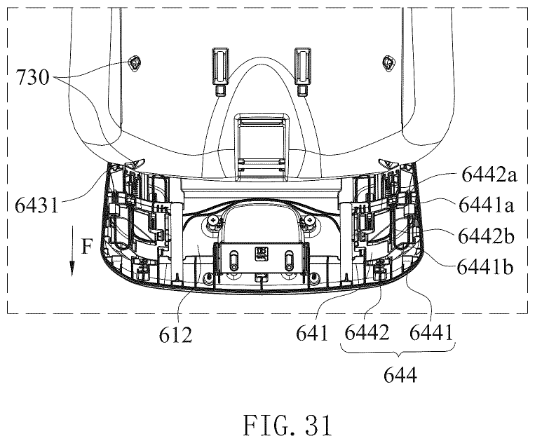

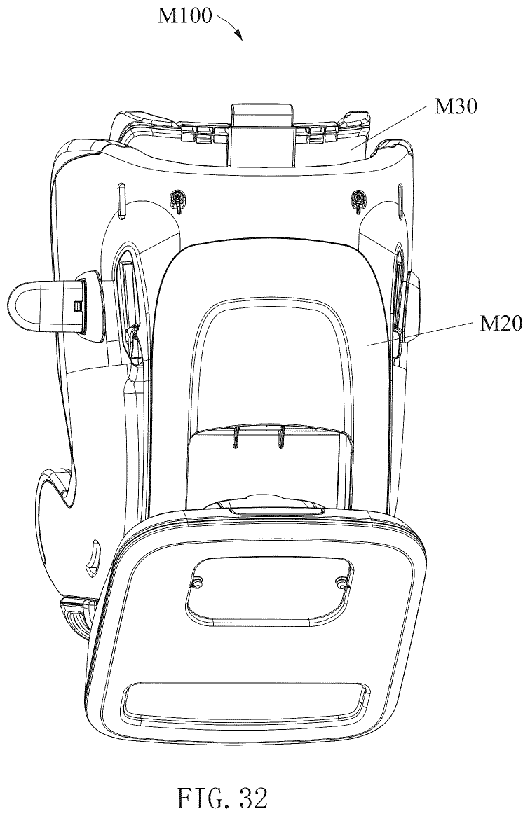

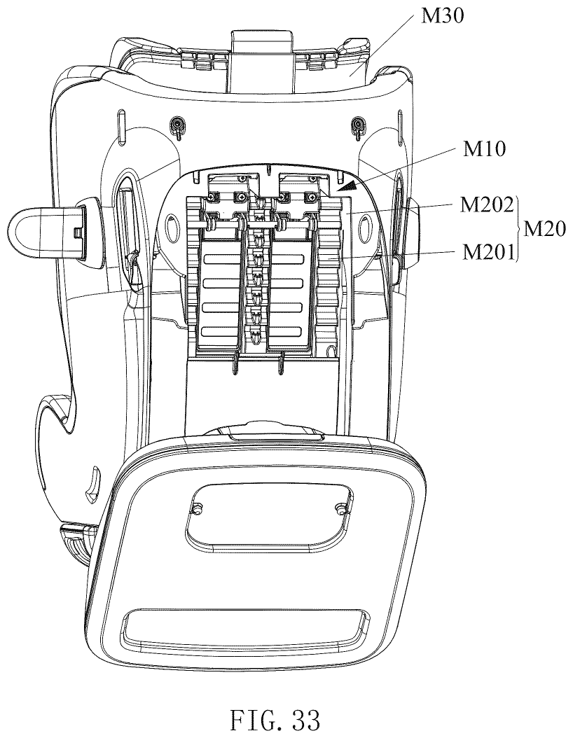

Based on this, referring to FIGS. 32 and 33, an embodiment of the present disclosure provides a baby carrier M100. The baby carrier M100 includes a carrier body M20, a headrest M30 and a headrest height adjustment mechanism M10. The headrest M30 is movably disposed on the carrier body M20, and the headrest height adjustment mechanism M10 is located between the headrest M30 and the carrier body M20.

The carrier body M20 includes a backrest M202. The carrier body M20 is also provided with a height adjustment apparatus M201 for adjusting the height of the headrest M30 vertically. In this embodiment, the height adjustment apparatus M201 is formed by a plurality of positioning grooves provided on the backrest M202, and the positioning grooves are arranged at intervals along a vertical direction of the carrier body M20. The height of the headrest M30 may be adjusted with respect to the backrest M202 through the cooperation between the headrest height adjustment mechanism M10 and the height adjustment apparatus M201. In this embodiment, the backrest M202 is a fixing structure. Of course, in other embodiments, the backrest M202 may also move along the vertical direction of the carrier body M20, but it is not limited thereto.

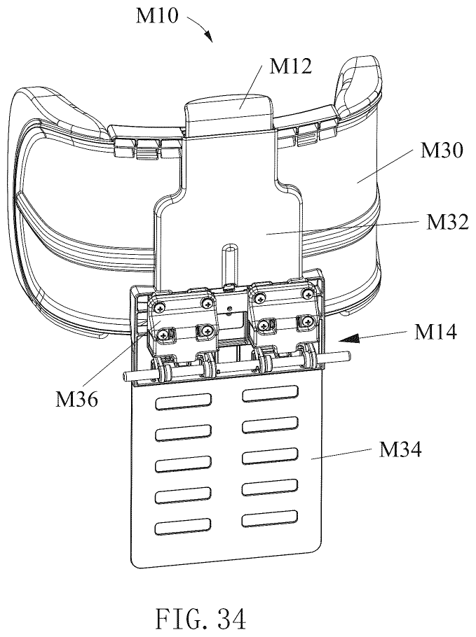

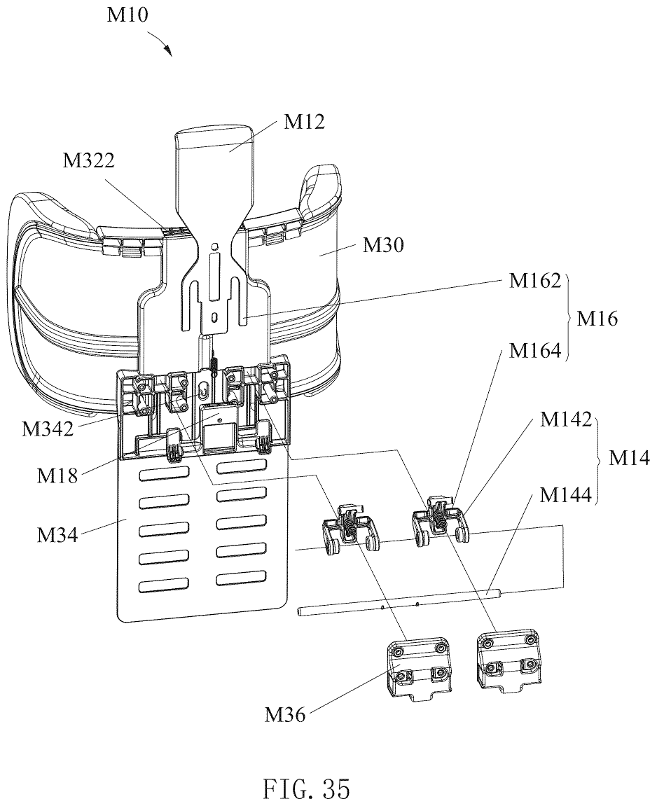

Referring to FIGS. 34 and 35, the headrest height adjustment mechanism M10 includes an operating element M12, a locking assembly M14, a safety lock mechanism M16, and a driving element M18. The operating element M12 is slidably disposed on the headrest M30, and has an initial position, a first operating position and a second operating position with respect to the headrest M30. The locking assembly M14 may be selectively locked with the height adjustment apparatus M201. The locking assembly M14 has a locking position where it is engaged with the height adjustment apparatus M201 and an unlocking position where it is separated from the height adjustment apparatus M201, and may be switched between the locking position and the unlocking position. The safety lock mechanism M16 may lock the locking assembly M14 in the locking position, and may unlock the locking assembly M14 under the action of switching the operating element M12 from the initial position to the first operating position. One end of the driving element M18 is slidably connected to the operating element M12, and the other end of the driving element M18 abuts against the locking assembly M14. When the operating element M12 is switched from the first operating position to the second operating position, the driving element M18 may be driven to move, thereby driving the locking assembly M14 to be switched from the locking position to the unlocking position.

Specifically, as shown in FIG. 34, the headrest M30 includes a limiting plate M32, a positioning plate M34 and two fixing cover plates M36. A limiting slot M322 (see FIG. 35) is formed in the limiting plate M32, and the operating element M12 passes through the limiting slot M322 and may move along the vertical direction in the limiting slot M322. The positioning plate M34 is connected with the bottom of the limiting plate M32. Each of the fixing cover plates M36 is fixed to the positioning plate M34 by a plurality of screws.

As shown in FIGS. 35 and 37, the operating element M12 is substantially formed as a sheet, and includes a handle M122 and a transmission element M124 connected with the handle M122. The handle M122 can facilitate the user to pull the operating element M12. The transmission element M124 is configured to transmit the movement of the operating element M12 to the driving element M18. The safety lock mechanism M16 includes a limiting element disposed on the operating element M12. Specifically, in this embodiment, the limiting element is a stop pin M162 integrally formed with and connected to the transmission element M124. The two stop pins M162 are located on two sides of the transmission element M124, and an extending direction of the stop pin M162 is the same as a moving direction of the transmission element M124. The transmission element M124 is also provided with an accommodating groove M1242, a hanging hole M1244 and a sliding groove M1246. The hanging hole M1244 and the sliding groove M1246 are located at two ends of the accommodating groove M1242 and adjacent to the accommodating groove M1242. It can be understood that the number of the stop pins M162 may also be one or more.

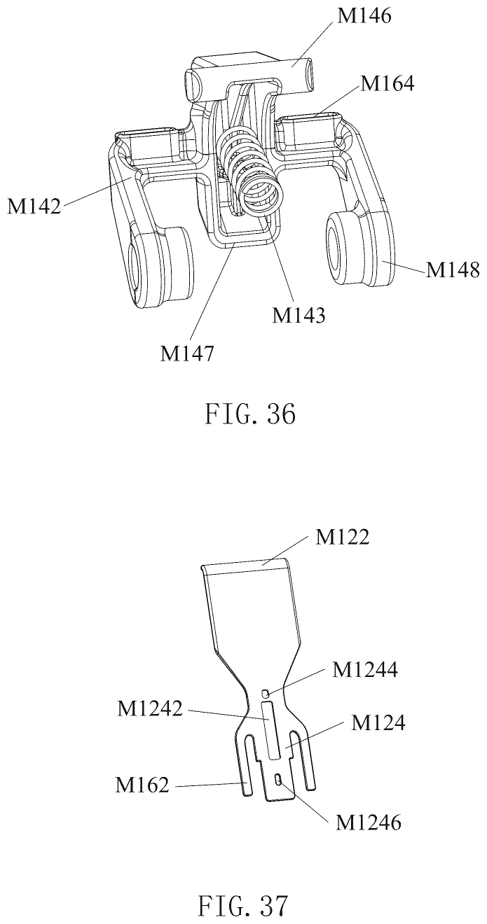

As shown in FIGS. 35 and 36, the locking assembly M14 includes a locking body M142 and a locking rod M144. A top portion of the locking body M142 has a pivoting part M146 pivoted with the fixing cover plate M36, so that the locking body M142 may rotate with respect to the headrest M30. The bottom of the locking body M142 is provided with a fitting bevel M147 abutting against the driving element M18. Two fixing parts M148 fixed with the locking rod M144 are further formed and extend on two sides of the locking body M142. The locking rod M144 passes through the two fixing parts M148 and may rotate together with the locking body M142, thereby switching between the locking position and the unlocking position. In the locking position, the locking rod M144 is locked with the height adjustment apparatus M201 of the carrier body M20, so that the position of the headrest M30 may be fixed. In the unlocking position, the locking rod M144 is separated from the height adjustment apparatus M201 of the carrier body M20, thereby facilitating the user to adjust the height of the headrest M30.

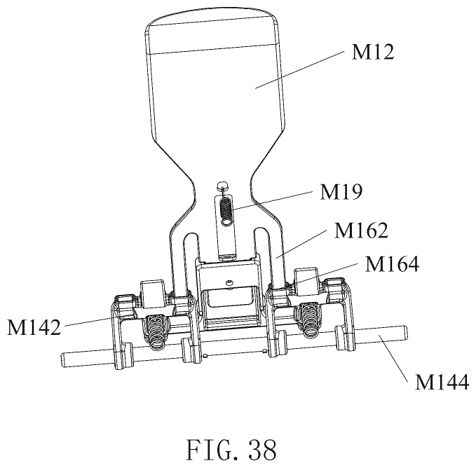

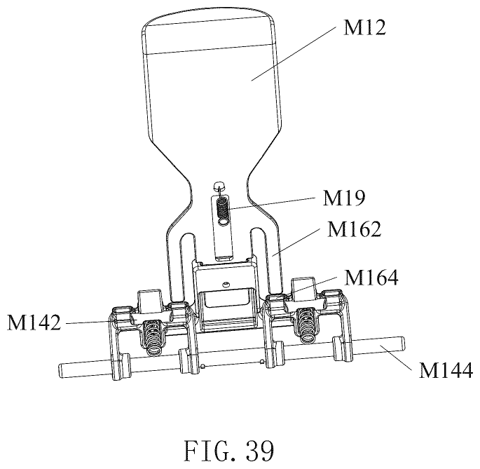

As shown in FIG. 36, the safety lock mechanism M16 further includes an engaging element provided on the locking body M142. Specifically, in this embodiment, the engaging element includes two engaging grooves M164 disposed on the locking body M142 and located on two sides of the fitting bevel M147. As shown in FIG. 38, when the stop pin M162 is inserted into the engaging groove M164, the locking body M142 can be prevented from rotating with respect to the fixing cover plate M36, thereby locking the locking rod M144 of the locking assembly M14 in the locking position. As shown in FIG. 39, when the stop pin M162 is disengaged from the engaging groove M164, the locking body M142 may rotate with respect to the fixing cover plate M36, so that the safety lock mechanism M16 unlocks the locking assembly M14. It can be understood that the number of the engaging grooves M164 may also be one or more. In addition, it can be understood that the positions of the stop pin M162 and the engaging groove M164 may also be interchanged. In other words, the limiting element of the safety lock mechanism M16 may also be an engaging groove, and correspondingly, the engaging element of the safety lock mechanism M16 is a stop pin, as long as the limiting element cooperates with the engaging element to lock the locking assembly M14 in the locking position. In this embodiment, the locking assembly M14 may be locked or unlocked in the locking position by moving the operating element M12 to insert the stop pin M162 into the engaging groove M164, and other mechanisms are not required, so that the structure is very simplified, thereby achieving reductions of the overall volume and production cost. In addition, a moving direction of the operating element M12 is a direction of unlocking, so the operation is smooth and labor-saving.

In order to further lock the locking assembly M14 in the locking position, as shown in FIG. 36, the locking assembly M14 further includes a first elastic element M143. One end of the first elastic element M143 abuts against the locking body M142, and the other end of the first elastic element M143 abuts against an inner side of the fixing cover plate M36, thereby providing an elastic force to keep the locking rod M144 locked with the height adjustment apparatus M201, that is, to keep the locking body M14 in the locking position.

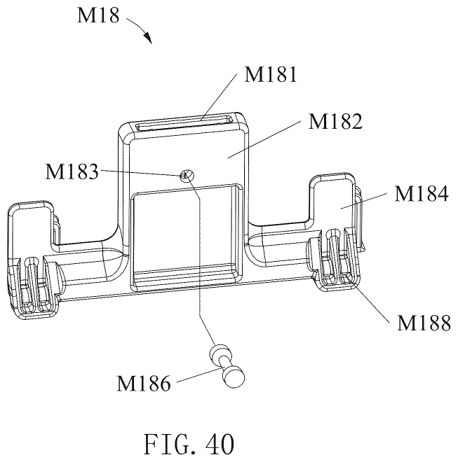

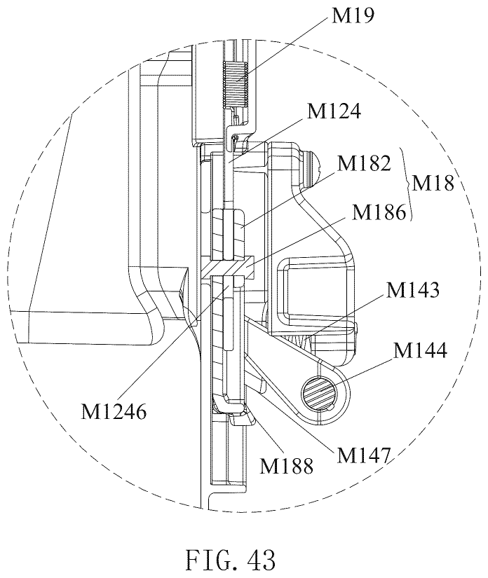

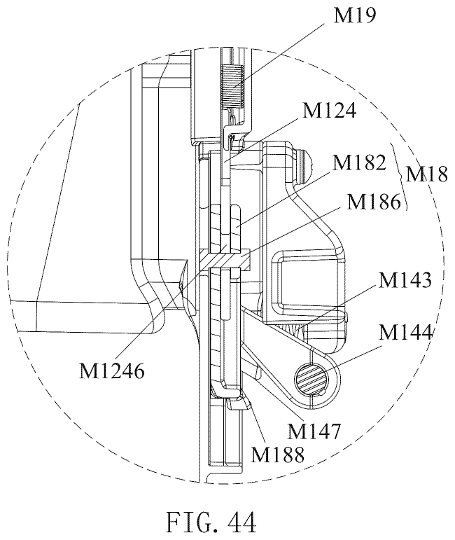

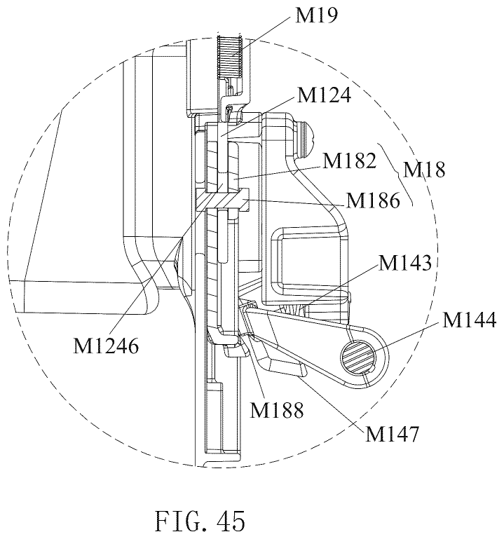

Referring to FIG. 40, the driving element M18 includes a body part M182 and abutting parts M184 located at two sides of the body part M182. The body part M182 is provided with an inserting slot M181 for accommodating the transmission element M124. The body part M182 is also provided with a positioning hole M183 communicating with the inserting slot M181. The driving element M18 further includes a pulling element M186 disposed in the positioning hole M183. In this embodiment, the pulling element M186 is a cylindrical positioning pin fixedly disposed in the positioning hole M183. Referring to FIGS. 37 and 43 again, the sliding groove M1246 on the transmission element M124 is substantially an elongated hole, which corresponds to the position of the positioning hole M183, and a length of the sliding groove M1246 is larger than a diameter of the positioning hole M183. In other words, the pulling element M186 fixed in the positioning hole M183 may slide vertically in the sliding groove M1246 along an extending direction of the sliding groove M1246. When the operating element M12 moves between the initial position shown in FIG. 43 and the first operating position shown in FIG. 44, the pulling element M186 slides in the sliding groove M1246, so that the driving element M18 does not move with the movement of the operating element M12. However, when the operating element M12 is switched from the first operating position as shown in FIG. 44 to the second operating position as shown in FIG. 45, the pulling element M186 will move under the driving of the transmission element M124 since the pulling element M186 abuts against a side wall of the sliding groove M1246, so that the driving element M18 moves together with the operating element M12, and then the driving element M18 drives the locking body M142 of the locking assembly M14 to rotate with respect to the headrest M30, so as to be switched between the locking position and the unlocking position.

As shown in FIGS. 40, 41A, 41B and 43, the abutting part M184 has a driving bevel M188, and the bottom of the locking body M142 has a fitting bevel M147 abutting against the driving bevel M188. Through the cooperation between the driving bevel M188 and the fitting bevel M147, a vertical linear motion of the driving element M18 may be converted into a rotational motion of the locking body M142.

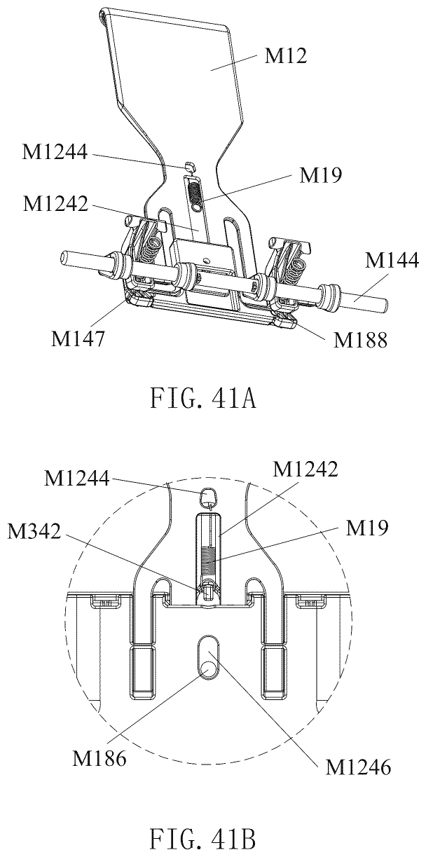

Referring to FIGS. 41A and 41B, in order to automatically return the operating element M12 from the second operating position to the initial position, the headrest height adjustment mechanism M10 further includes a second elastic element M19 disposed between the headrest M30 and the operating element M12. In this embodiment, the second elastic element M19 is a tension spring. A body of the second elastic element M19 is located in the accommodating groove M1242 of the transmission element M124, one end of the second elastic element M19 is fixed in the hanging hole M1244, and the other end of the second elastic element M19 is fixed on one fixing hook M342 of the headrest M30. The second elastic element M19 may provide an elastic force that enables the operating element M12 to automatically return to the initial position from the second operating position and be kept in the initial position.

In combination with FIGS. 32 to 45, the working principle of the baby carrier M100 will be described in detail below.

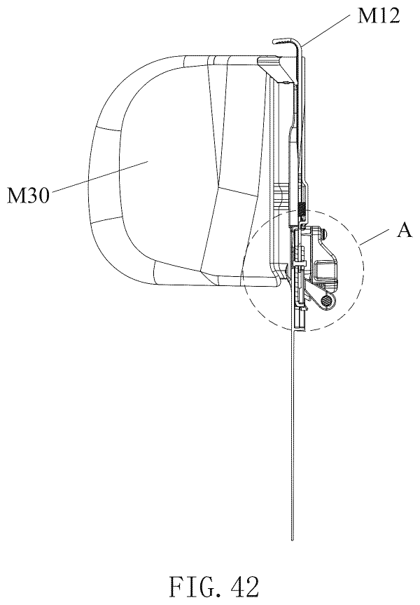

When the operating element M12 is in the initial position shown in FIGS. 42 and 43, the locking rod M144 of the locking assembly M14 is locked with a certain location of the height adjustment apparatus M201 under the action of the first elastic element M143, and as shown in FIG. 38, the stop pin M162 of the safety lock mechanism M16 is inserted into the engaging groove M164, thereby locking the locking assembly M14 in the locking position.

When it is necessary to adjust the height of the headrest M30 with respect to the carrier body M20, the operating element M12 in the initial position may be pulled upward. The operating element M12 slides upward from the initial position to the first operating position against the elastic force of the second elastic element M19 (a state shown in FIGS. 43 to 44). At this time, as shown in FIG. 39, the stop pin M162 of the safety lock mechanism M16 is disengaged from the engaging groove M164, thereby unlocking the locking assembly M14, and the locking assembly M14 may freely rotate between the locking position and the unlocking position. In addition, since the pulling element M186 slides in the sliding groove M1246, the driving element M18 does not move with the movement of the operating element M12.

Continuing to pull the operating element M12 in the first operating position upwards, the operating element M12 continues to slide from the first operating position to the second operating position against the elastic force of the second elastic element M19 (a state shown in FIGS. 44 and 45). Since the pulling element M186 abuts against the side wall of the sliding groove M1246, the pulling element M186 will move under the driving of the transmission element M124, so that the driving element M18 moves together with the operating element M12. Through the cooperation between the driving bevel M188 and the fitting bevel M147, the vertical linear motion of the driving element M18 may be converted into the rotational motion of the locking body M142. In other words, during the upward movement of the driving element M18, the fitting bevel M147 of the locking assembly M14 is pushed by the driving bevel M188 of the driving element M18 to rotate against the elastic force of the first elastic element M143, thereby switching the locking assembly M14 from the locking position to the unlocking position. At this time, the locking rod M144 of the locking assembly M14 is disengaged from the height adjustment apparatus M201, and the height of the headrest M30 may be freely adjusted vertically with respect to the carrier body M20.

After the headrest M30 is adjusted to the target position, the operating element M12 is released, and the operating element M12 is restored under the elastic action of the second elastic element M19, that is, returns from the second operating position to the initial position. The locking assembly M14 is switched from the unlocking position to the locking position under the action of the first elastic element M143, the locking rod M144 of the locking assembly M14 is locked with a certain location of the height adjustment apparatus M201 again, and the stop pin M162 of the safety lock mechanism M16 is inserted into the locking groove M164, thereby locking the locking assembly M14 in the locking position.

It can be understood that in another embodiment, if the driving bevel M188 is directly disposed at a lower end of the operating element M12, the operating element M12 may also be used to directly drive the locking assembly M14 to be switched from the locking position to the unlocking position, and at this time, the driving element M18 may also be omitted.

The headrest height adjustment mechanism M10 is provided with a safety lock mechanism M16, and the operating element M12 has an initial position, a first operating position and a second operating position. The safety lock mechanism M16 is driven to unlock the locking assembly M14 by the switching of the operating element M12 from the initial position to the first operating position, so that the subsequent unlocking operation may be carried out only when the operating element M12 moves to the first operating position. At the same time, one end of the driving element M18 is slidably disposed on the operating element M12, and the other end of the driving element M18 abuts against the locking assembly M14. By switching the operating element M12 from the first operating position to the second operating position, the driving element M18 moves and drives the locking assembly M14 to be switched from the locking position to the unlocking position, thereby achieving unlocking. In other words, when the operating element M12 is in the initial position, the locking rod M144 of the locking assembly M14 may be firmly locked with the height adjustment apparatus M201 under the dual effects of the elastic force of the first elastic element M143 and the safety lock mechanism M16, and even if the baby carrier M100 is slightly hit during the emergency braking of the vehicle, the locking rod M144 will not be easily separated from the height adjustment apparatus M201, thereby reducing the possibility of location jumping and improving the safety of the baby carrier M100.

In addition, child carriers are generally designed in multi-level mode so as to be suitable for children of different sizes. At the same time, in order to adapt to the use of children of different sizes, a length of the crotch belt needs to be designed in an adjustable mode.

In order to firmly secure a child on the child carrier, such as a safety seat, the child safety is generally provided with a binding system. The binding system includes a shoulder belt, a waist belt, a crotch belt and fasteners connecting them together. In order to be suitable for children of different sizes, the length of the crotch belt is generally adjustable, but the existing crotch belt length adjustment device for the child carrier has a complicated structure and is inconvenient to use.

Therefore, the present disclosure provides a crotch belt length adjustment device, which is able to adjust a length of the crotch belt with different locations, so as to be suitable for children of different sizes, and the location adjustment of the crotch belt is convenient and quick.

It should be noted that the child carrier in the present disclosure may be various appliances for carrying children, including but not limited to a child safety seat, a trolley, a dining chair, a rocking chair, etc. For the convenience of description, the child carrier is taken as a child safety seat as an example in the following description.

The present disclosure will be described in detail with reference to the accompanying drawings.

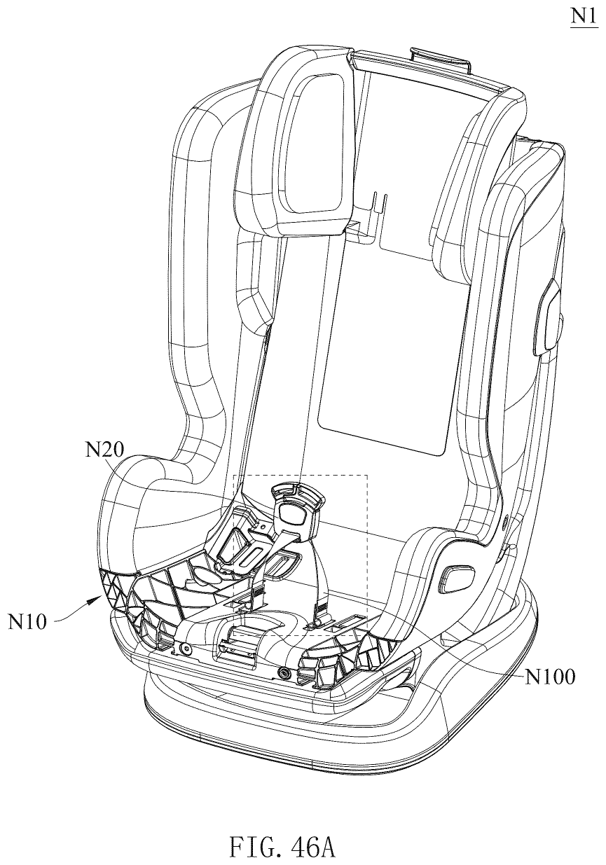

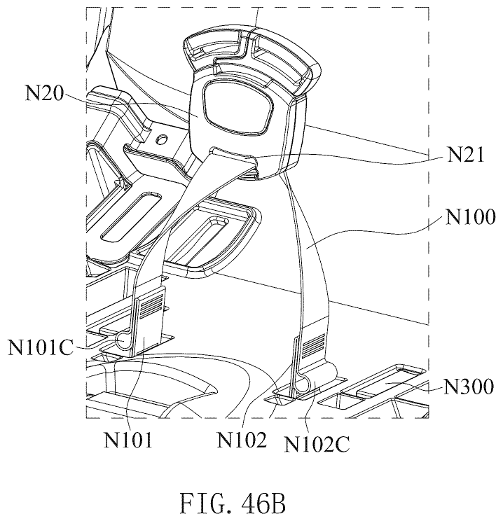

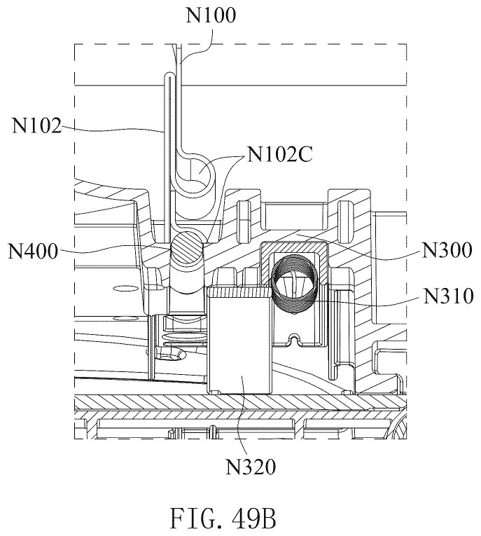

FIGS. 46A to 53B show a child carrier N1 using the crotch belt length adjustment device according to the present disclosure. The child carrier N1 includes a seat part N10 and a backrest. It should be noted that the seat part N10 in the present disclosure refers to a seat housing.

The crotch belt length adjustment device according to the present disclosure includes a crotch belt provided with a plurality of crotch belt adjustment structures and an adjustment connecting element.

### Crotch Belt

The crotch belt N100 has a first end N101 and a second end N102. Moreover, at least one of the first end N101 and the second end N102 is a movable end detachably connected to the seat part N10 of the child carrier N1.

In an embodiment shown in FIGS. 46A and 46B, both of the first end N101 and the second end N102 are movable ends. However, the present disclosure is not limited thereto. In an embodiment, one of the first end N101 and the second end N102 is a movable end, which may be adjusted to adjust the length of the crotch belt N100, or may be detached from the seat part N10 but cannot be adjusted, and the other of the first end N101 and the second end N102 is fixed at a fixing end of the seat part N10.

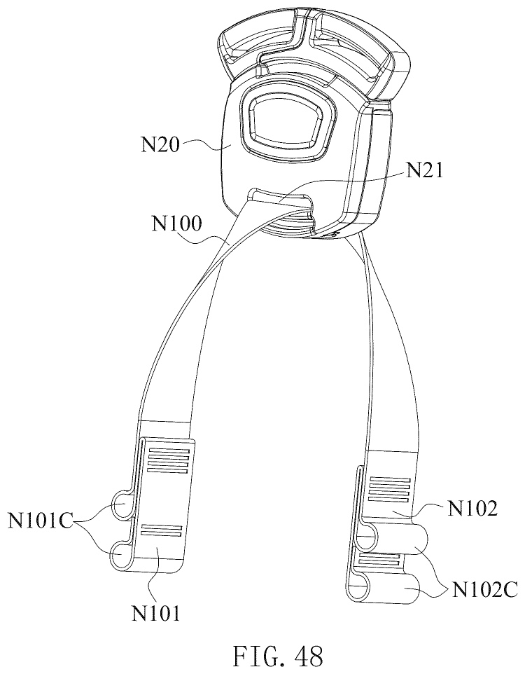

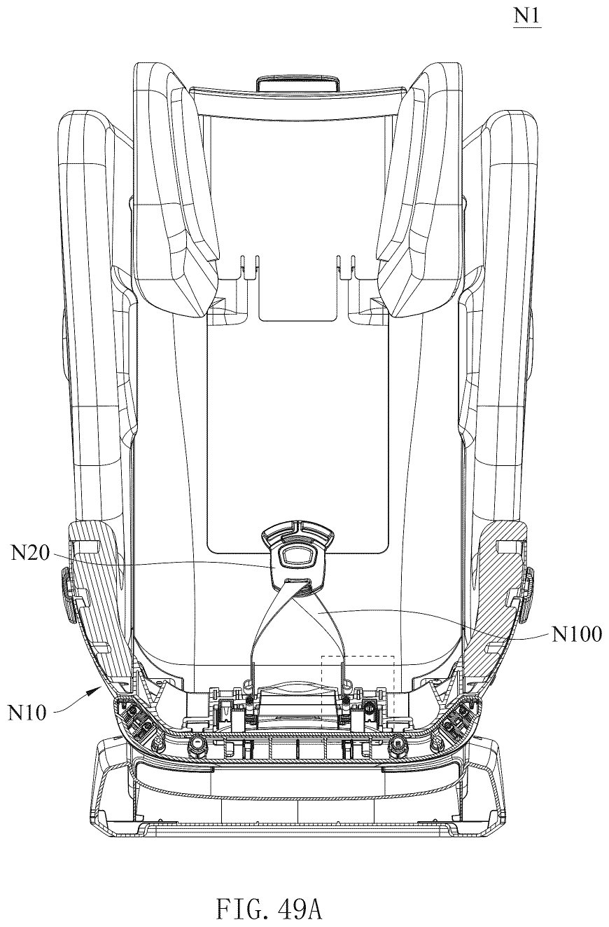

In order to adjust the length of the crotch belt N100, as shown in FIG. 48, the movable end of the crotch belt N100 is provided with a plurality of crotch belt adjustment structures N101C and N102C arranged along a length direction of the crotch belt N100.

Specifically, in an embodiment shown in FIG. 48, the first end N101 is provided with a plurality of (two as shown in FIG. 48) first crotch belt adjustment structures N101C arranged along the length direction of the crotch belt N100, and the second end N102 is provided with a plurality of (two as shown in FIG. 48) second crotch belt adjustment structures N102C arranged along the length direction of the crotch belt N100.

It should be understood that the number of crotch belt adjustment structures N101C and N102C on each movable end of the crotch belt N100 may be two or more. The more the number of crotch belt adjustment structures N101C and N102C is, the more locations the length of the crotch belt N100 can be adjusted.

In addition, the structure and the number of the first crotch belt adjustment structure N101C at the first end N101 and the second crotch belt adjustment structure N102C at the second end N102 may be the same or different.

Since a plurality of crotch belt adjustment structures N101C and N102C are arranged along the length direction of the crotch belt N100, the length between portions of the crotch belt N100 at two ends thereof connected with the seat part N10 (that is, where the crotch belt adjustment structures N101C and N102C are located or where the fixing ends are located) when different crotch belt adjustment structures N101C and N102C at the movable end of the crotch belt N100 are connected to the seat part N10 of the child carrier N1, so that the length of the crotch belt N100 can be adjusted.

When both of the first end N101 and the second end N102 of the crotch belt N100 are movable ends, and the crotch belt adjustment structures N101C and N102C on the movable ends are not connected to the seat part N10 of the child carrier N1, the crotch belt N100 may be detached from the seat part N10.

In the embodiment shown in FIG. 48, the crotch belt adjustment structure N101C and N102C is an adjusting sleeve formed by folding an end of the crotch belt N100 with respect to the crotch belt itself for several times. Moreover, the folded part at the end of the crotch belt N100 may be kept in a folded state by sewing, gluing or the like, so that the adjusting sleeve may be kept in a fixed size.

However, the present disclosure is not limited thereto. The crotch belt adjustment structure N101C and N102C may also be an adjusting ring, an adjusting hook or an adjusting rod, or other structures as long as it is arranged along the length direction of the crotch belt N100 and can be quickly and conveniently connected or detached from the seat part N10 of the child carrier N1. Moreover, each movable end of the crotch belt N100 may be provided with one or more of an adjusting sleeve, an adjusting ring, an adjusting hook and an adjusting rod along the length direction of the crotch belt N100.

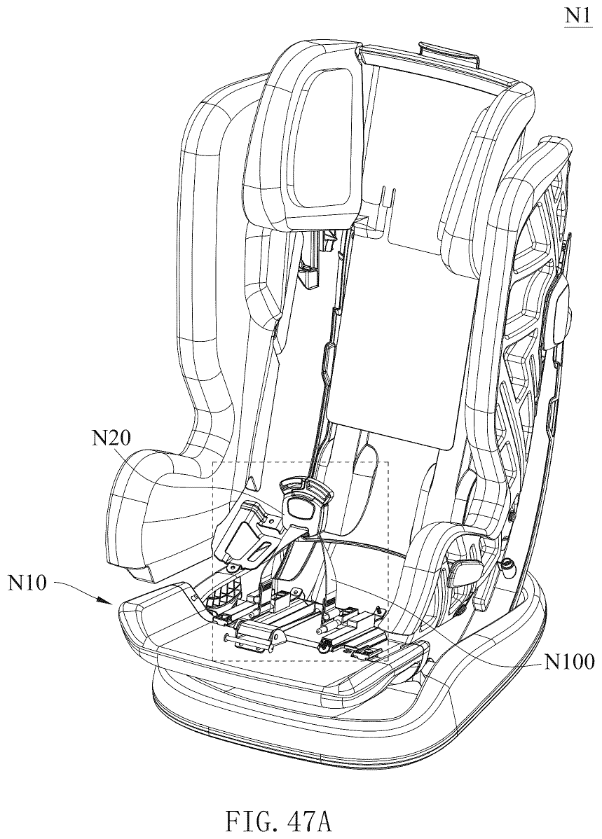

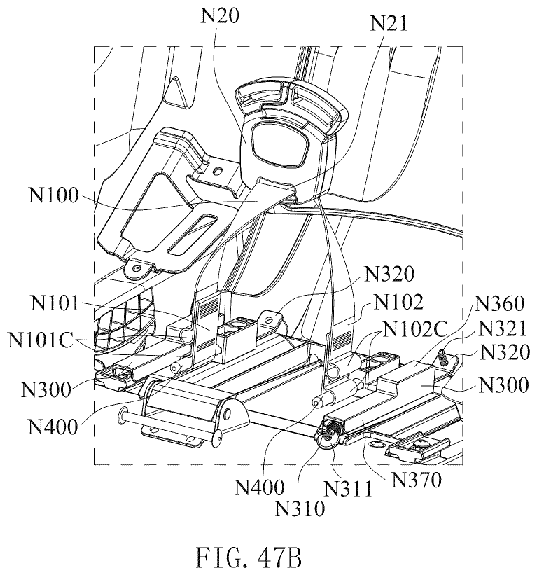

In addition, in order to facilitate the connection between the crotch belt N100 and a shoulder belt or a waist belt, in the embodiment shown in FIGS. 46A to 47B, a fastener N20 may be provided on the crotch belt N100.

More specifically, as shown in FIGS. 46B and 47B, the fastener N20 may be provided with a fastener perforation N21 through which the crotch belt N100 passes, which enables the fastener N20 to slide along the crotch belt N100, thereby adjusting the position of the fastener N20 on the crotch belt N100.

### Adjustment Connecting Element

In order to quickly and conveniently connect or detach the crotch belt adjustment structure N101C and N102C on the movable end with or from the seat part N10 of the child carrier N1, an adjustment connecting element N400 is disposed on the seat part N10.

The number and the position of the adjustment connecting element N400 correspond to those of the movable end of the crotch belt N100, and the adjustment connecting element N400 is disposed to be engaged with one of the crotch belt adjustment structures N101C and N102C on the corresponding movable end to prevent the corresponding movable end from moving away from the seat part N10, and to be disengaged from the crotch belt adjustment structure N101C or N102C to allow the corresponding movable end to move away from the seat part N10.

Specifically, as shown in FIGS. 46A to 47B, in the embodiment in which both of the first end N101 and the second end N102 of the crotch belt N100 are movable ends, two adjustment connecting elements N400 respectively corresponding to the two movable ends are arranged on the seat part N10 along a width direction of the seat part N10.

However, in the embodiment in which only one of the first end N101 and the second end N102 of the crotch belt N100 is a movable end, only one adjustment connecting element N400 corresponding to the one movable end may be arranged on the seat part N10.

In the embodiment in which both the first end N101 and the second end N102 of the crotch belt N100 are movable ends, but the length of the crotch belt N100 at one end thereof is not adjustable, two adjustment connecting elements N400 corresponding to the first end N101 and the second end N102 are arranged on the seat part N10, but only one crotch belt adjustment structure N101C or N102C is disposed on one of the first end N101 and the second end N102, so that the crotch belt N100 may be disassembled when it is necessary, but the length of the crotch belt N100 at only one end may be adjusted.

The engagement and disengagement between the adjustment connecting element N400 and the crotch belt adjustment structure(s) N101C and/or N102C may be implemented by various manners.

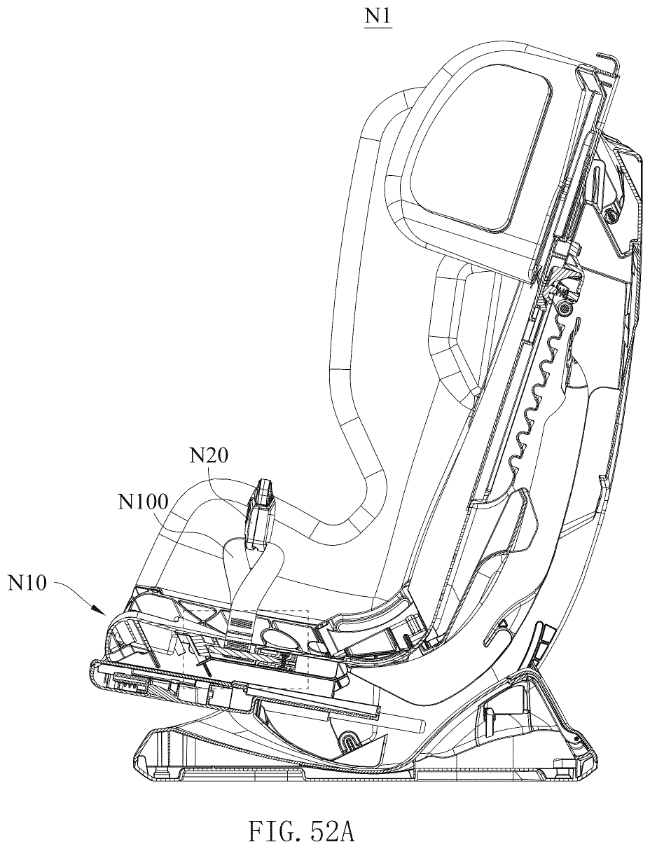

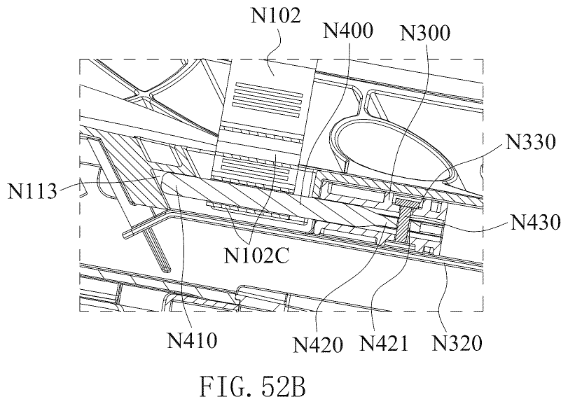

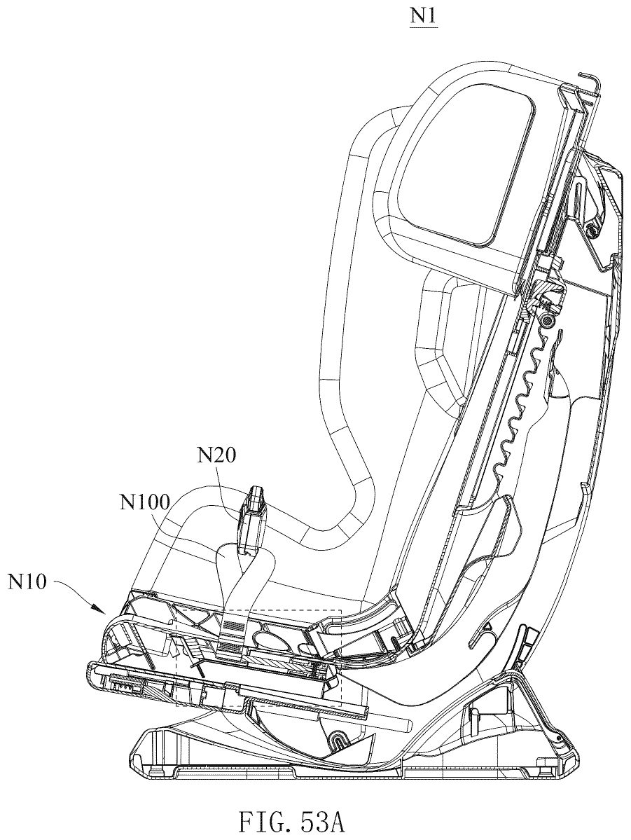

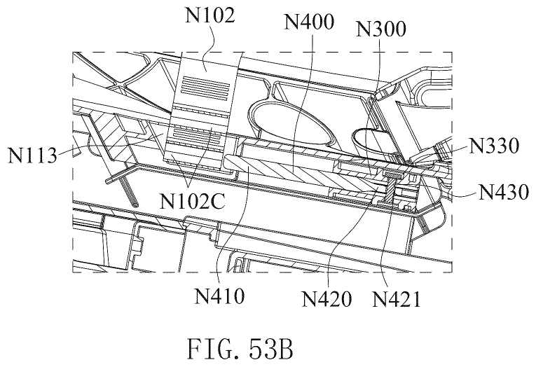

In the embodiment shown in FIGS. 52A to 53B, the crotch belt adjustment structures N101C and N102C are adjusting sleeves. Correspondingly, the adjustment connecting element N400 is disposed on the seat part N10 to be movable between the first position and the second position. Moreover, the adjustment connecting element N400 is disposed to be engaged with one of the adjusting sleeves as the crotch belt adjustment structure N101C or N102C at a first position (as shown in FIG. 52B) to prevent the corresponding movable end from moving away from the seat part N10, and to be disengaged from the adjusting sleeve at a second position (as shown in FIG. 53B) to allow the corresponding movable end to move away from the seat part N10.

In addition, in order to facilitate the engagement and disengagement between the crotch belt adjustment structure(s) N101C and/or N102C and the adjustment connecting element N400, as shown in FIGS. 52B and 53B, the adjustment connecting element N400 may have a connecting element engaging part N410 that is engaged with or disengaged from one of the crotch belt adjustment structures N101C and N102C.

The connecting element engaging part N410 may be rod-shaped or protruding-shaped, and have a cross section having a shape and a size corresponds to a cross section of the crotch belt adjustment structure N101C, N102C, such as an adjusting sleeve, an adjusting ring or an adjusting hook, so that the connecting element engaging part N410 may be easily inserted or withdrawn from the crotch belt adjustment structure N101C, N102C, so as to implement the engagement and disengagement between the adjustment connecting element N400 and the crotch belt adjustment structure N101C, N102C.

In order to prevent the upper surface of the seat part N10 from affecting the riding comfort of children due to the adjustment connecting element, as shown in FIGS. 46A to 47B, the adjustment connecting element N400 is disposed below the upper surface of the seat part N10. At the same time, the upper surface of the seat part N10 is also provided with a through hole, so that the crotch belt adjustment structure N101C, N102C may be engaged with the adjustment connecting element N400 after passing through the through hole.

However, it should be understood that the adjustment connecting element N400 may be disposed above the upper surface of the seat part N10. In this case, the upper surface of the seat part N10 may not be provided with a through hole.

Further, in order to ensure the stability of the connection between the adjustment connecting element N400 and the crotch belt adjustment structures N101C and N102C, as shown in FIG. 52B, the seat part N10 is provided with a seat connecting hole N113. The connecting element engaging part N410 of the adjustment connecting element N400 is engaged with one of the crotch belt adjustment structures N101C and N102C and then accommodated in the seat connecting hole N113. The seat connecting hole N113 on the seat part N10 plays a role in positioning the connecting element engaging part N410, so that when the crotch belt N100 applies a pulling force on the connecting element engaging part N410 via the crotch belt adjustment structures N101C and N102C, the adjustment connecting element N400 can be prevented from moving.

Of course, the present disclosure is not limited thereto. The engagement and disengagement between the adjustment connecting element N400 and the crotch belt adjustment structures N101C and N102C can be implemented by other various manners.

For example, the crotch belt adjustment structure N101C, N102C may be a plurality of adjusting rings or adjusting hooks arranged on the crotch belt N100 along the length direction of the crotch belt N100. Correspondingly, the adjustment connecting element N400 may be a hook element arranged on the seat part N10. The hook element as the adjustment connecting element N400 may be hooked with or disengaged from one of the adjusting rings or hooks as the crotch belt adjustment structure N101C, N102C, so that different crotch belt adjustment structures N101C and N102C may be connected with or detached from the seat part N10 of the child carrier N1 quickly and conveniently, so as to implement the location adjustment of the crotch belt N100, thereby realizing the adjustment of the length of the crotch belt N100.

In a first embodiment, the hook element as the adjustment connecting element N400 may be fixed differently with respect to the seat part N10, and the user moves the adjusting ring or the adjusting hook as the crotch belt adjustment structure N101C, N102C to implement the engagement and disengagement between the crotch belt adjustment structure N101C, N102C and the adjustment connecting element N400.

In a second embodiment, the hook element as the adjustment connecting element N400 may be disposed on the seat part N10 to be movable between the first position and the second position. Moreover, the adjustment connecting element N400 may be disposed to be engaged with one of the crotch belt adjustment structures N101C and N102C at a first position and be disengaged from the crotch belt adjustment structure N101C, N102C at a second position. In the second embodiment, since the adjustment connecting element N400 may translate and/or rotate between the first position and the second position with respect to the seat part N10, the user may more flexibly engage and disengage the crotch belt adjustment structure N101C, N102C and the adjustment connecting element N400 by moving the crotch belt adjustment structure N101C, N102C and the adjustment connecting element N400.

For another example, the crotch belt adjustment structure N101C, N102C may be a plurality of adjusting rods arranged on the crotch belt N100 along the length direction of the crotch belt N100. Correspondingly, the adjustment connecting element N400 may be a sleeve structure fixedly or movably arranged on the seat part N10. The user inserts or withdraws one of the adjusting rods as the crotch belt adjustment structure N101C, N102C into or from the sleeve structure as the adjustment connecting element N400, so that the corresponding movable end of the crotch belt N100 is prevented or allowed to move away from the seat part N10, so as to adjust the location of the crotch belt N100, thereby realizing the adjustment of the length of the crotch belt N100.

### Adjustment Operating Element

The crotch belt length adjustment device according to the present disclosure may further include an adjustment operating element N300. The adjustment operating element N300 is disposed to be exposed from the seat part N10 and may be applied with an action force to drive the adjustment connecting member N400 to move between the first position and the second position. Thus, the user may conveniently operate, from the outside of the seat part N10 via the adjustment operating element N300, the adjustment connecting element N400 to move.

It should be understood that the adjustment operating element N300 is not an essential member of the crotch belt length adjustment device according to the present disclosure. In the case that the user can easily approach the adjustment connecting element N400 from the outside of the seat part N10, it is unnecessary to provide the adjustment operating element N300. For example, in an embodiment in which the crotch belt adjustment structure N101C, N102C is formed as a plurality of adjusting rings or adjusting hooks and the adjustment connecting element N400 is a hook element arranged on the seat part N10, it is unnecessary to provide the adjustment operating element N300.

When the adjustment connecting element N400 is arranged inside the seat part N10 for aesthetic and comfort, it is not easy for the user to approach the adjustment connecting element N400 from the outside of the seat part N10. At this time, the crotch belt length adjustment device according to the present disclosure may include an adjustment operating element N300, so that the user may operate the adjustment connecting element N400 via the adjustment operating element N300.

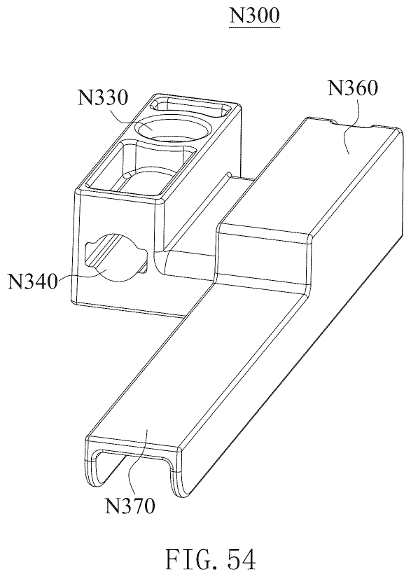

In order to facilitate the user to apply an action force on the adjustment operating element N300, in the embodiment shown in FIGS. 47B and 54, the adjustment operating element N300 may be provided with an operating element stress part N360. The operating element stress part N360 may be a stepped structure or a protruding structure of the adjusting operating element N300 exposed from the seat part N10.

In an embodiment, the adjustment operating element N300 may be integrally formed with the adjustment connecting element N400. That is, the adjustment operating element N300 may be formed as a part (for example, an operating handle) of the adjustment connecting element N400 protruding from the seat part N10, so that the user may operate the adjustment connecting element N400.

In the embodiment shown in FIGS. 47A and 47B, the adjustment connecting element N400 may be a member independent of the adjustment operating element N300. Moreover, the adjustment operating element N300 is movably arranged on the seat part N10, and the adjustment connecting element N400 is connected with the adjustment operating element N300. Thus, when the adjustment operating element N300 moves with respect to the seat part N10, it may drive the adjustment connecting element N400 to move between the first position and the second position.

In order to facilitate the connection between the adjustment connecting element N400 and the adjustment operating element N300, as shown in FIGS. 52A to 53B and 56, the adjustment connecting element N400 has a connecting element driving part N420 connected with the adjustment operating element N300.

In the embodiment shown in FIGS. 54 to 56, the adjustment operating element N300 is provided with an operating element fixing hole N330, the connecting element driving part N420 of the adjustment connecting element N400 is provided with a connecting element fixing hole N421, and a connecting element fixing structure N430 (see FIGS. 52B and 53B) passes through the operating element fixing hole N330 and the connecting element fixing hole N421 to connect the adjustment connecting element N400 with the adjustment operating element N300.

The connecting element fixing structure N430 may be a rivet, a screw, a pin, or the like.

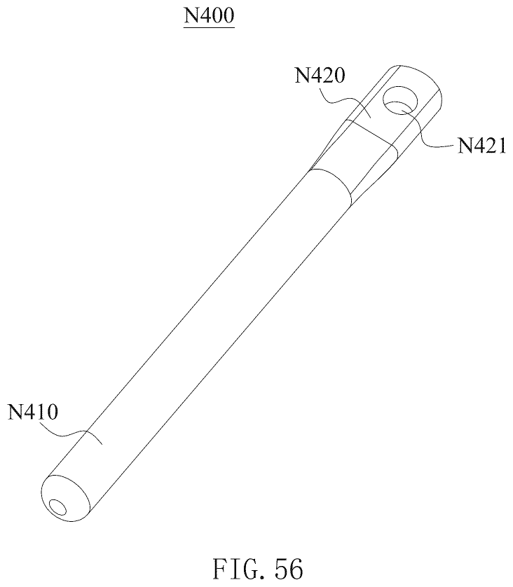

In order to avoid the difficulty in aligning the operating element fixing hole N330 and the connecting element fixing hole N421 caused by the relative rotation between the adjustment operating element N300 and the adjustment connecting element N400 during connection, in the embodiments shown in FIGS. 54 to 56, the connecting element driving part N420 may be disposed to have a non-circular cross section (for example, flat as shown in FIG. 56, oval or polygonal), and the adjustment operating element N300 is provided with an operating element connecting groove N340. A shape and a size of a cross section of the operating element connecting groove N340 correspond to those of a cross section of the connecting element driving part N420, so that the connecting element driving part N420 cannot rotate about its axis in the operating element connecting groove N340.

Of course, the adjustment connecting element N400 and the adjustment operating element N300 may be connected in various other manners.

For example, the operating element fixing hole N330 of the adjustment operator N300 is formed as a threaded hole, and the connecting element driving part N420 of the adjustment connecting element N400 is formed as a threaded structure, so that the adjustment connecting element N400 and the adjustment operator N300 are directly screwed together.

Alternatively, the adjustment connecting element N400 and the adjustment operating element N300 may be welded together.

In order to guide the movement of the adjustment operating element N300 with respect to the seat part N10, the crotch belt length adjustment device according to the present disclosure may further include an operating element guiding structure N320, which is arranged at the seat part N10 and disposed to guide the movement of the adjustment operating element N300.

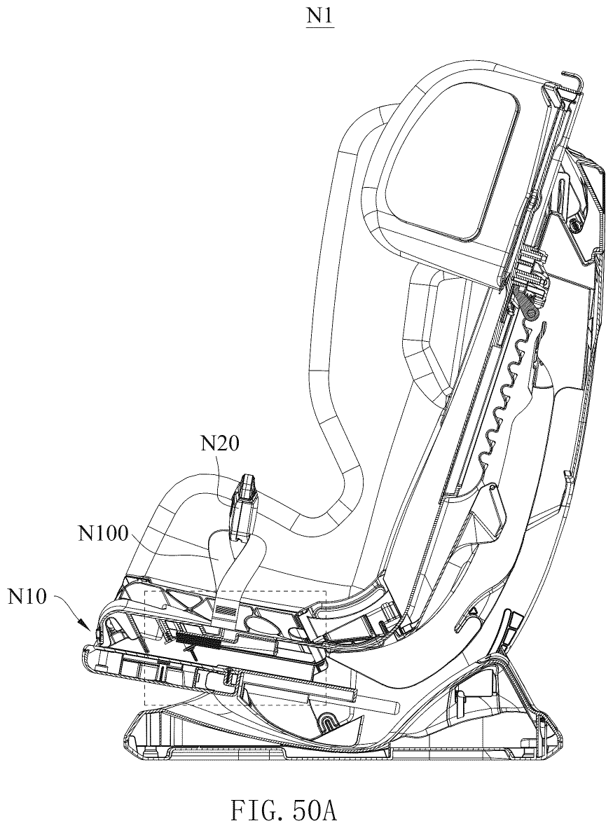

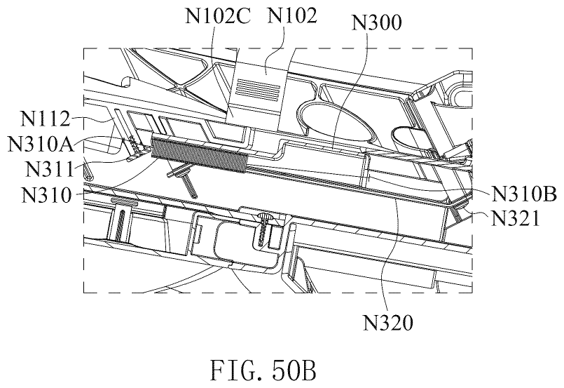

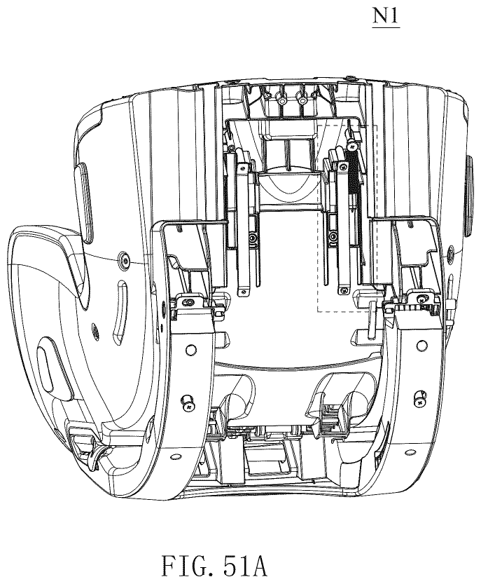

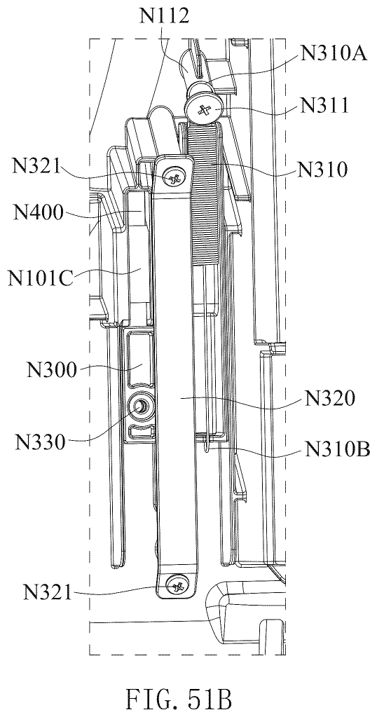

In the embodiment shown in FIGS. 50B and 51B, the operating element guiding structure N320 is a strip structure, and both ends of the operating element guiding structure N320 are fixed to the seat part N10 through guiding structure fixing elements N321, respectively. The guiding structure fixing element N321 may be a screw, an anchor or other fixing elements.

Of course, the operating element guiding structure N320 may be in other structures. For example, the operating element guiding structure N320 may be a guiding groove, a guiding rib or a guiding pin, and it may take the form of concave-convex fit between the guiding structure N320 and the adjusting operating element N300.

In order to simplify the operation of the crotch belt length adjustment device, in the embodiment shown in FIGS. 50A to 51B, the crotch belt length adjustment device according to the present disclosure may further include an operating element restoring elastic element N310, which is disposed to directly or indirectly drive the adjustment connecting element N400 to move towards the first position and keep it in the first position.

Under the elastic force of the operating element restoring elastic element N310, the adjustment connecting element N400 tends to move to the first position where it is engaged with the crotch belt adjustment structure N101C, N102C, and tends to be kept in the first position. Thus, after the adjustment connecting element N400 is engaged with one of the crotch belt adjustment structures N101C and N102C on the movable end of the crotch belt N100, the operating element restoring elastic element N310 is restored to keep the adjustment connecting element N400 in the first position, so as to ensure the stability of the crotch belt length adjustment device.

Moreover, since the operating element restoring elastic element N310 drives the adjustment connecting element N400 to be kept in the first position, it is possible to prevent the adjustment connecting element N400 from being accidentally separated from the crotch belt adjustment structure N101C, N102C. This improves the safety of the crotch belt length adjustment device.

When the user is ready to disengage the adjustment connecting element N400 from the crotch belt adjustment structure N101C, N102C, the user only needs to overcome the elastic force of the operating element restoring elastic element N310 and move the adjustment connecting element N400 towards the second position where it is detached from the crotch belt adjustment structure N101C, N102C.

In an embodiment, the operating element restoring elastic element N310 may be directly connected with the adjustment connecting element N400, so as to directly drive the adjustment connecting element N400 to move towards the first position and to be kept in the first position.

In the embodiment shown in FIGS. 50A to 51B, the operating element restoring elastic element N310 is connected with the adjustment operating element N300, so that the adjustment connecting element N400 is indirectly driven via the adjusting operating element N300 to move towards the first position and to be kept in the first position.

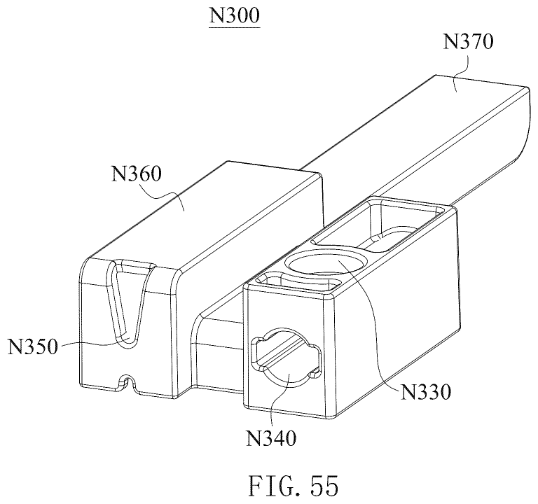

In this embodiment, as shown in FIGS. 50A to 51B, the operating element restoring elastic element N310 is a tension spring having a restoring elastic element first end N310A and a restoring elastic element second end N310B. The restoring elastic element first end N310A is connected to the restoring elastic element connecting structure N112 on the seat part N10, and the restoring elastic element second end N310B is connected to the restoring elastic element connecting part N350 on the adjustment operating element N300 (see FIG. 55).

In addition, as shown in FIGS. 54 and 55, the adjustment operating element N300 may be provided with a restoring elastic element accommodating part N370 in which the operating element restoring elastic element N310 is accommodated. Thus, it can be avoided that the adjustment operating element N300 and the operating element restoring elastic element N310 occupy different spaces respectively, and the structure of the entire crotch belt length adjustment device can be more compact.

Although relative terms such as “upper” and “lower” are used in this specification to describe the relative relationship of one component to another component in the drawings, these terms are used in this specification only for convenience, such as directions in the examples described according to the drawings. It can be appreciated that if the illustrated device is turned over to be upside down, a component described as being “upper” will become a component that is “lower”. Other relative terms, such as “top”, “bottom”, “left”, “right”, etc. also have similar meanings. When a structure is “on” another structure, it may refer to a structure integrally formed on another structure, or refer to a structure “directly” provided on another structure, or a structure “indirectly” provided on another structure through other structure(s).

In this specification, the terms “a”, “an”, “the”, “said” and “at least one” are used to indicate the presence of one or more elements/components and the like. ; the terms “including”, “including” and “having” are used to indicate an open-ended inclusive meaning and mean that there may be additional elements/components and the like in addition to the listed elements/components and the like; the terms “first”, “second”, “third” and the like are used only as marks, not as restrictions on the number of their objects.

Unless otherwise defined, all terms including technical and scientific terms used herein have the same meaning as commonly understood by those ordinary skilled in the art to which the present disclosure belongs. It should also be understood that terms should be interpreted to have a meaning consistent with their meaning in the context of the related art, and will not be interpreted in an idealized or overly formal sense unless expressly defined herein.

It should be understood that, while preferred embodiments have been shown and described above, the present disclosure is not limited to the specific embodiments described above. Various modifications and variations can be made by those skilled in the art without departing from the spirit and scope of the appended claims. Therefore, it should be noted that various modifications and variations cannot be considered as departing from the technical spirit and scope of the present disclosure.

1. A child safety seat comprising:
a seat part;
a support plate disposed at a front end of the seat part, and being slidable and telescopic with respect to the seat part;
wherein the support plate is provided with a support plate adjustment mechanism for adjusting a length of the support plate protruding from the seat part,
wherein the support plate comprises a support plate body and a first connecting element, one end of the first connecting element is fixed on the support plate body, and the other end of the first connecting element protrudes from the support plate body and is inserted into the seat part, so that the support plate is slidably connected to the seat part,
wherein the support plate adjustment mechanism comprises a positioning structure movably disposed on the support plate body so as to be able to position the support plate in at least one position of the seat part,
wherein the support plate adjustment mechanism further comprises an operating mechanism at least partially movably disposed on the support plate and comprising two operating elements slidably disposed at two sides of the support plate and sliding between a locking position and a releasing position,
wherein, when any one of the operating elements is in the locking position, the operating element drives the positioning structure to lock the support plate and the seat part, so as to limit movement of the support plate with respect to the seat part; and when the operating element is in the releasing position, the operating element drives the positioning structure to be unlocked, so as to allow the support plate to move with respect to the seat part.

2. The child safety seat according to claim 1, wherein an upper surface of the support plate body is provided with a second connecting element, the second connecting element is in sliding engagement with a lower surface of the seat part, wherein the second connector is a guiding rib or a guiding groove.

3. The child safety seat according to claim 1, wherein
the positioning structure comprises a first positioning structure and a second positioning structure disposed at two sides of the support plate body, respectively;
the support plate adjusting mechanism further comprises a first traction element and a second traction element;
one end of the first traction element is connected to the operating element at one side, and the other end of the first traction element is connected to the first positioning structure; one end of the second traction element is connected to the operating element at the same side, and the other end of the second traction element is connected to the second positioning structure; when the operating element slides from the locking position to the releasing position, the first traction element pulls the first positioning structure to be unlocked, and the second traction element pulls the second positioning structure to be unlocked;
wherein at least one of the first traction element and the second traction element is a flexible element.

4. The child safety seat according to claim 1, wherein the operating mechanism further comprises:
two driving elements slidably disposed on the support plate respectively and moving with operation of a corresponding operating element; and
two traction element sets, each of which comprises a first traction element and a second traction element, wherein the first traction element is configured to be connected between the operating element and the driving element located at the same side of the support plate, so that the driving element is linked with the operating element, and wherein the second traction element is connected between the operating element at one side of the support plate and the driving element at the other side of the support plate.

5. The child safety seat according to claim 1, wherein
the positioning structure comprises a first locking element disposed at the support plate body and moving between a locking position and an unlocking position;
a lower surface of the seat part is provided with a second locking element, an upper surface of the support plate body is provided with a through hole passing therethrough, and an engaging end of the first locking element is able to extend and retract from the through hole to engage with and disengage from the second locking element.

6. The child safety seat according to claim 5, wherein the first locking element is a locating hook pivoted to a lower surface of the support plate body, and the locating hook is able to be pivoted so that the engaging end protrudes from the upper surface of the support plate body when it is in the locking position, and retracts into the support plate body when it is in the unlocking position.

7. The child safety seat according to claim 5, wherein the first locking element is a positioning pin, the second locking element is a positioning hole, a plurality of second locking elements are disposed in a front and rear direction of the seat part, and the positioning structure further comprises an elastic element disposed to bias the first locking element towards a direction extending out of the through hole.

8. The child safety seat according to claim 1, wherein
the first connecting element comprises two connecting tubes disposed at two sides of the support plate body;
two ends of the operating element are sleeved on the two connecting tubes respectively, so as to slide the operating element in a direction of extension of the connecting tube, the operating element is provided with a pushing rib thereon, the pushing rib has a guiding bevel, and when the operating element slides, the guiding bevel moves against the first locking element from the locking position to the unlocking position.

9. The child safety seat according to claim 4, wherein the first traction element comprises a first traction wire having a first end, a wire body portion and a second end, and the first end and the second end of the first traction wire are fixedly connected to the operating element and the driving element at the same side respectively, so that the driving element is driven to move when the operating element is operated.

10. (canceled)

11. The child safety seat according to claim 4, wherein
the first traction element comprises a first traction wire and a first sheath, the first end of the first traction wire is fixedly connected to the driving element at the same side, and the second end of the first traction wire is fixedly connected to the support plate;
the first sheath is sleeved on the first traction wire, a first end of the first sheath abuts against the support plate, and a second end of the first sheath is connected with the operating element.

12. The child safety seat according to claim 9, wherein the second traction element comprises a second traction wire and a second sheath,
wherein a first end of the second traction wire is connected to the operating element on one side of the support plate, and a second end of the second traction wire is connected to the driving element on the other side of the support plate; and
wherein the second sheath is sleeved on the second traction wire, a first end of the second sheath is fixed on one side of the support plate, and a second end of the second sheath is fixed on the other side of the support plate.

13. The child safety seat according to claim 5, wherein
the first locking element is fixedly disposed on a fixing seat at an end of the support plate, the operating mechanism is provided with an inclined slot thereon, and the inclined slot is slidingly fit to the fixing seat through a linkage pin disposed on the fixing seat,
when the operating mechanism is operated, the operating mechanism moves the fixing seat through the inclined slot so as to drive the first locking element to disengage from the seat part.

14. The child safety seat according to claim 1, wherein the support plate body is provided with a limiting rib, the seat part comprises a cover at a front side, the cover is provided with a limiting slot, and a vertical segment of the limiting rib is able to be blocked by a blocking part of the limiting slot, so as to prevent the support plate from being separated from the seat part.

15. A child safety seat comprising:
a seat part;
a support plate disposed at a front end of the seat part and being slidable and telescopic with respect to the seat part;
a positioning structure movably disposed on the support plate body, so as to position the support plate in at least one position of the seat part; and
an operating mechanism disposed on the support plate to drive the positioning structure to lock and unlock the support plate and the seat part,
wherein the operating mechanism comprises:
two operating elements disposed at two sides of the support plate or the seat part respectively;
two driving elements movably disposed on the support plate, respectively, and being movable along with operation of a corresponding operating element; and
two traction element sets, each of which comprises a first traction element and a second traction element, wherein the first traction element is configured to be connected between the operating element and the driving element located at the same side of the support plate, so that the driving element is linked with the operating element, and the second traction element is connected between the operating element located at one side of the support plate and the driving element located at the other side of the support plate,
wherein at least one of the first traction element and the second traction element is a flexible element.

16. The child safety seat according to claim 15, further comprising a base configured to place the seat part, wherein the seat part is slidable with respect to the base to adjust an inclination angle.

17. The child safety seat according to claim 15, wherein the child safety seat further comprises a headrest height adjustment mechanism comprising:
an operating element slidably disposed on a headrest, and having an initial position, a first operating position and a second operating position with respect to the headrest;
a locking assembly configured to be locked with a height adjustment apparatus, wherein the locking assembly has a locking position and an unlocking position and is able to be switched between the locking position and the unlocking position;
a driving element, one end of which is slidably connected to the operating element, and the other end of which abuts against the locking assembly, wherein, as the operating element is switched from the first operating position to the second operating position, the driving element moves and drives the locking assembly to be switched from the locking position to the unlocking position; and
a safety lock mechanism comprising a limiting element disposed on the operating element and an engaging groove disposed on the locking assembly, wherein when the operating element is switched from the first operating position to the second operating position, the limiting element is inserted and matched with the engaging groove to lock the locking assembly in the locking position, so that the locking assembly is switched from the locking position to the unlocking position; and when the operating element is switched from the initial position to the first operating position, the limiting element is separated from the engaging groove, so that the safety lock mechanism unlocks the locking assembly.

18. The child safety seat according to claim 17, wherein
a sliding direction of the limiting element is the same as that of the operating element.

19. The child safety seat according to claim 17, wherein the locking assembly is rotatably switched between the locking position and the unlocking position under the driving of the driving element, and comprises a locking body and a locking rod for locking with the height adjustment apparatus, wherein one end of the locking body has a pivoting part pivoted with the headrest, and the locking rod is fixed on the other end of the locking body.

20. The child safety seat according to claim 17, wherein the operating element is provided with a sliding groove, the driving element comprises a pulling element located in the sliding groove, when the operating element moves between the initial position and the first operating position, the pulling element slides in the sliding groove, and as the operating element is switched from the first operating position to the second operating position, the pulling element moves together with the operating element and drives the locking assembly to be switched from the locking position to the unlocking position, and
wherein, the child safety seat further comprises a second elastic element disposed between the headrest and the operating element, and the second elastic element provides an elastic force to keep the operating element in the initial position.

21. The child safety seat according to claim 15, wherein the child safety seat further comprises a crotch belt length adjustment device comprising:
a crotch belt having a movable end detachably connected to the seat part of the child carrier, wherein the movable end is provided with a plurality of crotch belt adjustment structures arranged along a length direction of the crotch belt;
an adjustment connecting element arranged on the seat part, engaged with one of the crotch belt adjustment structures on the movable end to prevent a corresponding movable end from moving away from the seat part, and disengaged from the crotch belt adjustment structure to allow the corresponding movable end to move away from the seat part, wherein the adjustment connecting element is disposed on the seat part to be movable between a first position and a second position, and the adjustment connecting element is disposed to be engaged with one of the crotch belt adjustment structures at the first position and disengaged from the crotch belt adjustment structure at the second position;
an adjustment operating element disposed to be exposed from the seat part and applied with an action force to drive the adjustment connecting element to move between the first position and the second position; and
an operating element restoring elastic element disposed to directly or indirectly drive the adjustment connecting element to move towards the first position and keep the adjustment connecting element in the first position.
